(19) United States
(12) Patent Application Publication
(10) Pub. No.: US 2022/0083509 A1
(43) Pub. Date: Mar. 17, 2022

(54) FILE TRANSFER SYSTEMS AND METHODS

(71) Applicant: Citrix Systems, Inc., Fort Lauderdale, FL (US)

(72) Inventors: Praveen Raja Dhanabalan, Bangalore (IN); Anudeep Athlur, Bangalore (IN); Anuj Magazine, Bengaluru (IN)

(21) Appl. No.: 17/083,416

(22) Filed: Oct. 29, 2020

(30) Foreign Application Priority Data
Sep. 16, 2020 (IN) 202041040088

(51) Int. Cl. G06F 16/14; G06F 16/13; G06F 16/182; H04L 29/08; H04L 29/06

(52) U.S. Cl. CPC G06F 16/152; G06F 16/137; H04L 67/42; H04L 67/06; G06F 16/183

(57) ABSTRACT

A computing system may compare a first hash with a second hash, the first hash generated by a client device using a first section of a file at the client device and the second hash generated using first data stored by the computing system. In response to a match between the first and second hashes, the computing system may generate a copy of the file with use of the first data to avoid delay caused by upload of the first section of the file from the client device.

### CROSS-REFERENCE TO RELATED APPLICATIONS

This application claims priority under 35 U.S.C. § 119(a) to Provisional Application No. 202041040088, entitled FILE TRANSFER SYSTEMS AND METHODS, which was filed with the Indian Patent Office on Sep. 16, 2020, the entire contents of which are incorporated herein by reference for all purposes.

### BACKGROUND

Various file sharing systems have been developed that allow users to store and/or retrieve files or other data to and/or from a repository. ShareFile®, offered by Citrix Systems, Inc., of Fort Lauderdale, Fla., is one example of a system that provides such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves comparing, by a computing system, a first hash with a second hash, the first hash generated by a client device using a first section of a file at the client device and the second hash generated using first data stored by the computing system. In response to a match between the first and second hashes, the computing system generates a copy of the file with use of the first data to avoid delay caused by upload of the first section of the file from the client device.

In some embodiments, a method involves sending, by a client device to a computing system, a first hash generated by the client device using a first section of a file at the client device. The client device receives from the computing system an indication that the first hash matches a second hash stored by the computing system, the second hash having been generated using first data stored by the computing system. Based at least in part on the received indication, the client device refrains from sending a copy of the first section of the file to the computing system for inclusion in a copy of the file generated by the computing system.

In some embodiments, a computing system comprises at least one processor and at least one computer-readable medium. The at least one computer-readable medium is encoded with instructions which, when executed by the at least one processor, cause the computing system to compare a first hash with a second hash, the first hash generated by a client device using a first section of a file and the second hash generated using first data stored by the computing system, and to generate, in response to a match between the first and second hashes, a copy of the file with use of the first data to avoid delay caused by upload of the first section of the file from the client device.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIGS. 1A and 1B include diagrams for a client-server file transfer system, and two corresponding flowcharts for the file upload process performed by the client-server file transfer system according to some embodiments of the present disclosure;

FIG. 2 is a diagram of a network environment in which some embodiments of the file transfer system disclosed herein may be deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like that shown in FIG. 2 may be configured to allow clients access to an example embodiment of a server-based file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6 is a sequence diagram for a file upload process according to some embodiments of the present disclosure;

FIG. 7 shows example components of the file transfer system in accordance with some embodiments;

FIG. 8A is a flowchart showing an example routine that may be performed by a hash generation engine shown in FIG. 7, according to some embodiments;

FIG. 8B shows an example hash table in which a hash generation engine may store the generated hashes and other data for the blocks, according to some embodiments;

FIG. 9 is a flowchart showing an example routine that may be performed by a server-side upload engine shown in FIG. 7, according to some embodiments;

FIG. 10 is a flowchart showing an example routine that may be performed by a hash comparison engine shown in FIG. 7, according to some embodiments;

FIG. 11A is a flowchart showing an example routine that may be performed by a client-side upload engine shown in FIG. 7, according to some embodiments; and

FIGS. 11B, 11C, and 11D show three different snapshots of a block table at three different times during one complete execution of the routine shown in FIG. 11A, according to some embodiments.

### DETAILED DESCRIPTION

For purposes of reading the description of the various embodiments below, the following descriptions of the sections of the specification and their respective contents may be helpful:

Section A provides an introduction to example embodiments of the file transfer system of this disclosure;

Section B describes a network environment which may be useful for practicing embodiments described herein;

Section C describes a computing system which may be useful for practicing embodiments described herein;

Section D describes embodiments of systems and methods for delivering shared resources using a cloud computing environment;

Section E describes example embodiments of systems for providing file sharing over networks;

Section F provides a more detailed description of example embodiments of the file transfer system that were introduced above in Section A; and

Section G describes example implementations of methods, systems/devices, and computer-readable media in accordance with the present disclosure.

### A. Introduction to Illustrative Embodiments of File Transfer Systems and Methods

In a file sharing environment, such as ShareFile®, a faster upload speed for a file may enhance the experience of a user. Various techniques have been utilized for increasing the upload speed, such as increasing transmission bandwidth or decreasing transmitted data using data compression. While such techniques can provide significant benefits, the inventors have recognized and appreciated that the upload speeds they enable may still be inadequate in at least some circumstances.

In a file sharing environment, like ShareFile®, some of the elements that may impact file upload times are the network upstream bandwidth, compression techniques in use, and additional optimizations from the file sharing protocol.

Regarding the network upstream bandwidth, some common network communication mediums, such as 4G, 3G, ADSL, etc., may typically have slower upload speeds in comparison their download speeds, thus negatively impacting the upload times of files.

Regarding the compression techniques, some well-known lossless compression techniques, such as bzip2, may be utilized to compress the file data before the uploading, and thus reduce the load on the network and the upload time. The amount of reduction, however, may be limited based on the compressibility of the file. For example, a binary file as opposed to a text file may exhibit less repeatable binary patterns that are compressible.

Regarding the capabilities of file sharing protocols, the protocol that operates between the client and server may additionally optimize the data transfer. For example, the protocol may utilize multiple streams to upload or download a file. Such a multi-stream technique, may use more than one connection/stream to upload a file, to increase the occupancy of the file upload with respect to the entire available upstream bandwidth of the network. The upload speed, however, may be limited by the upstream bandwidth of the network used for uploading the file. In such a technique, the protocol on the receiving side needs to avoid errors in re-assembling into a correct copy of the original file the data/packets that are received from different streams.

One available file sharing protocol is the P2P file sharing, which may be used for download optimization. In this protocol, the download of a file may be optimized by receiving portions of file from multiple peers, and re-assembling the data in the receiver. This protocol, however, may also be limited by the downstream bandwidth of the network.

Another technique for reducing the transmitted data is de-duplication, which may remove some redundant parts of the file from upload/download, and hence increase the speed of the file transfer. This method may avoid transferring parts that have become redundant due to one or more prior synchronizations between the sender and the receiver of the file.

Offered are novel systems and techniques for increasing the speed by which a file can be transferred from one computing system to another. In some implementations, a transferring computing system may identify one or more portions of the file that already exist at a receiving computing system and may refrain from transferring those portions of the file to the receiving computing system, thus reducing the quantity of data that needs to be transferred and, consequently, increasing the speed of the transfer. Advantageously, the techniques disclosed herein may be employed without the need to pre-synchronize data between the transferring computing system and the receiving computing system. In some implementations, the file transfer optimization techniques disclosed herein may be employed in a computing environment in which a central data repository stores a large number files for clients. A file sharing system, such as ShareFile®, is one example of such a system.

In some embodiments, the file transfer system may upload a file from a client device to a cloud service or a server (hereafter called “the server” for ease of reference) using one or more of the following steps.

The system may first identify a size for a file section, e.g., a block size that may be 1024 Bytes or 1KB. The server may prepare for the upload by dividing some or all of the files that are stored on the server's storage into blocks, and may store the blocks (hereafter therefore alternatively called “stored blocks”) in the storage. Moreover, the server may generate hashes for some or all of the stored blocks and generate a hash table, mapping the hashes to the blocks. The server may also store the hashes (hereafter therefore alternatively called “stored hashes”) and the hash table (hereafter alternatively called “the stored hash table”) in the storage. The hashes may be of a size that is significantly smaller than the block size, e.g., 16 Bytes. Different embodiments may use different sizes for the file sections or the hashes, and accordingly affect the speed or other properties of the upload.

Next, when a user selects a file to upload, one or more applications on a client device may divide the file into blocks (hereafter alternatively called “file blocks”). The client device may upload the file by sending the file blocks to the server through a first connection, starting from the first file block. The client device may also generate hashes of the file blocks (hereafter alternatively called “client hashes”), starting from the last file block, and may send the client hashes and the numbers of the file blocks corresponding to respective client hash to the server through a second connection.

On the server side, for the respective client hashes that the server receives from the client application, the server may search for an identical hash among the stored hashes using the stored hash table. When the server finds a stored hash that is identical to a client hash, the server may send an acknowledgement (or “ack”) message to the client device, and may utilize the stored block that corresponds to the found stored hash to generate the uploaded file.

On the client side, after the client device sends a client hash, the client device may receive such an ack message from the server, and, based on that ack message, may determine that the server's storage includes a stored block that is identical to the file block corresponding to the client hash. The client device may thus refrain from uploading that file block and thus avoid possible delay caused by upload of that file block.

When, on the other hand, the client device does not receive such an ack message, the client device may proceed with uploading the file block to the server.

Based the above technique, the file transfer system of some embodiments may reduce the upload time by skipping the upload of some of the file blocks. The time saved may be approximately equal to the number of the file blocks thus skipped multiplied by the difference between the time needed to upload a block and the lesser time needed to upload a client hash, minus additional overhead time, such as the time the client device spends generating the client hashes and/or uploading client hashes for which an identical hash is not found or the time the server spends comparing client hashes with stored hashes.

Additional details are provided below regarding the above and other embodiments, in relation to the drawings.

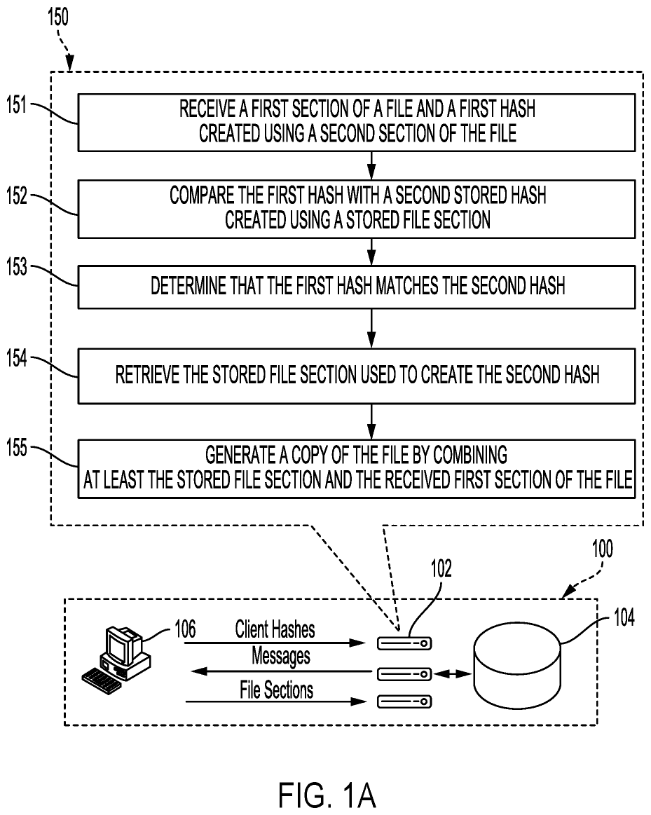

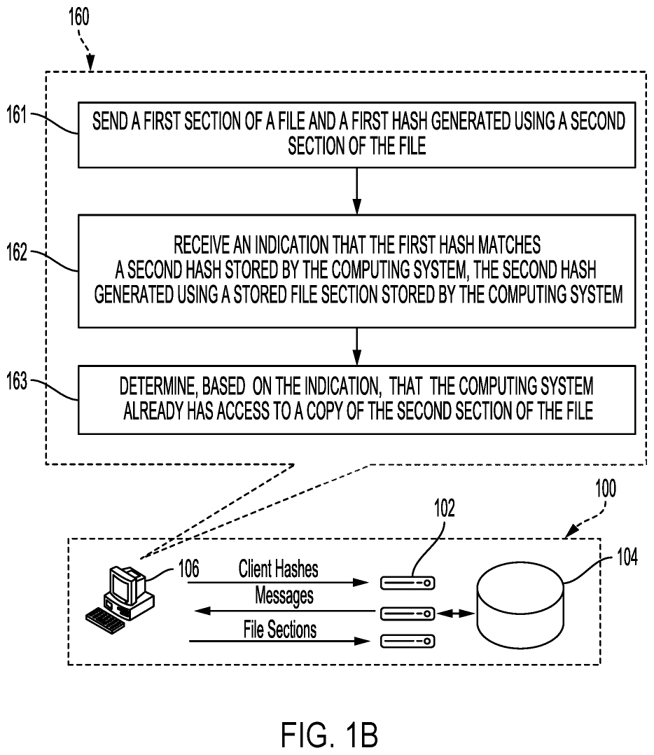

FIGS. 1A and 1B show a high-level implementation of a file transfer system 100 configured in accordance with some embodiments of the present disclosure. In addition, FIGS. 1A and 1B respectively show flowcharts for two routines 150 and 160 that, as detailed below, may be performed by one or more components of the file transfer system 100 in accordance with some embodiments of the present disclosure.

As shown in FIGS. 1A and 1B, the file transfer system 100 may include one or more servers 102 (hereafter alternatively called “the server 102”), one or more storage mediums 104 (hereafter alternatively called “the storage medium 104”), and one or more client devices 106 (hereafter alternatively called “the client device 106”).

The server 102 and the client device 106 may include one or more processors, and one or more computer-readable mediums encoded with instructions which, when executed by the one or more processors, cause the server 102 and/or the client device 106 to implement one or more functional modules or engines, and perform one or more routines, as further detailed below in relation to, for example, FIGS. 1A, 1B, 7, 8A, 8B, 9, 10, 11A, and 11B.

The storage medium 104 may include one or more types of storage mediums that the server 102 can write to or read from. As further detailed below, the storage medium 104 may store, among other things, data corresponding to one or more files or file sections. Moreover, the data stored on the storage medium 104 may be accessible to the server 102. Further, data stored by the server 102 may be stored on the storage medium 104.

In some implementations, the file transfer system 100, or one or more of its functional modules, may perform the routines 150 and 160 to upload a client file from the client device 106 to the server 102. The client file may be a file that is accessible to the client device 106, but not to the server 102. The uploading may result in generation of a copy of the client file, the copy being accessible to the server 102. As shown in FIGS. 1A and 1B, the routines 150 and 160 may include steps performed by the server 102 and the client device 106, respectively, to accomplish the uploading of the client file.

Referring first to the routine 150 in FIG. 1A, the server 102 may perform the routine 150 in collaboration with the client device 106 to accomplish the uploading.

More specifically, at a step 151 of the routine 150, the server 102 may compare a first hash with a second hash. The first hash may have been generated by the client device 106 using a first section of the client file. The second hash, on the other hand, may have been generated using first data stored by the server 102.

Next, at a step 152 of the routine 150, the server 102 may generate, in response to a match between the first and second hashes, a copy of the client file with use of the first data to avoid delay caused by upload of the first section of the client file from the client device 106.

Next, referring to the routine 160 shown in FIG. 1B, the client device 106 may perform the routine 160 in collaboration with the server 102 to accomplish the uploading. In particular, through the routine 160, the client device 106 may send some data related to the client file to the server 102 and may receive some messages from the server 102, as described above and further detailed below.

More specifically, at a step 161 of the routine 160, the client device 106 may send to the server 102 the first hash that may have been generated by the client device 106 using the first section of the client file.

Next, at a step 162 of the routine 160, the client device 106 may receive an indication from the server 102. The indication may, for example, indicate that the first hash matches the second hash having been generated using the stored first data.

Next, at a step 163 of the routine 160, the client device 106 may refrain, based at least in part on the received indication, from sending a copy of the first section of the client file to the server 102 for inclusion in the copy of the client file generated by the server 102.

Additional details and example implementations of embodiments of the present disclosure are set forth below in Section F, following a description of example systems and network environments in which such embodiments may be deployed.

### B. Network Environment

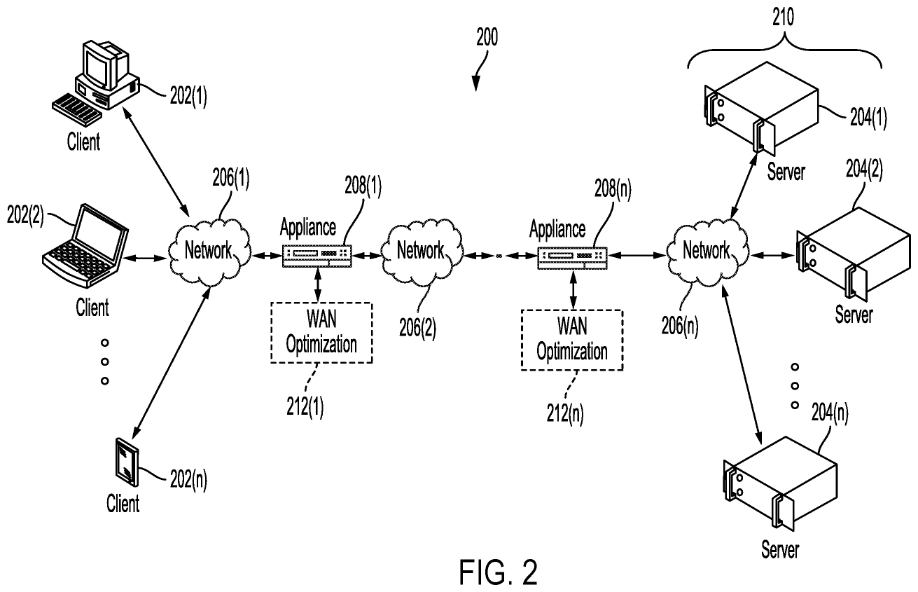

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), interne protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

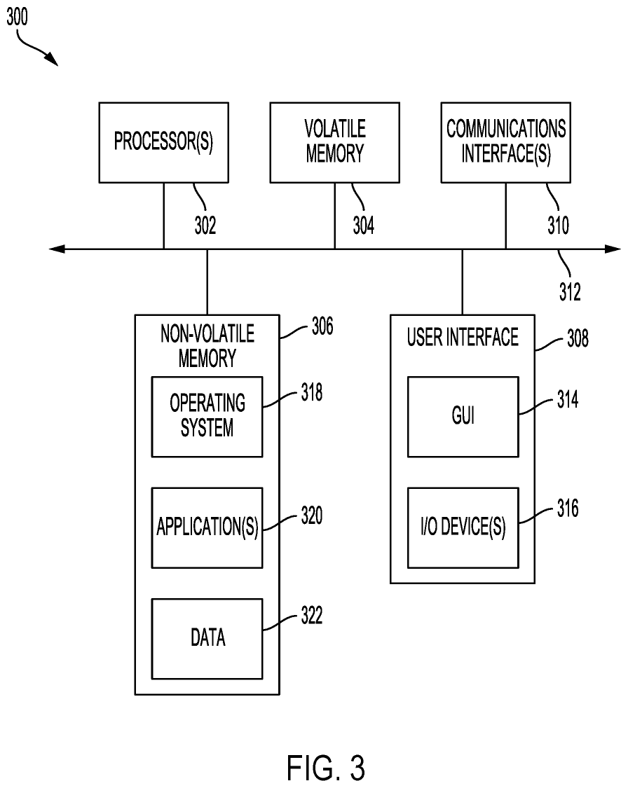

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

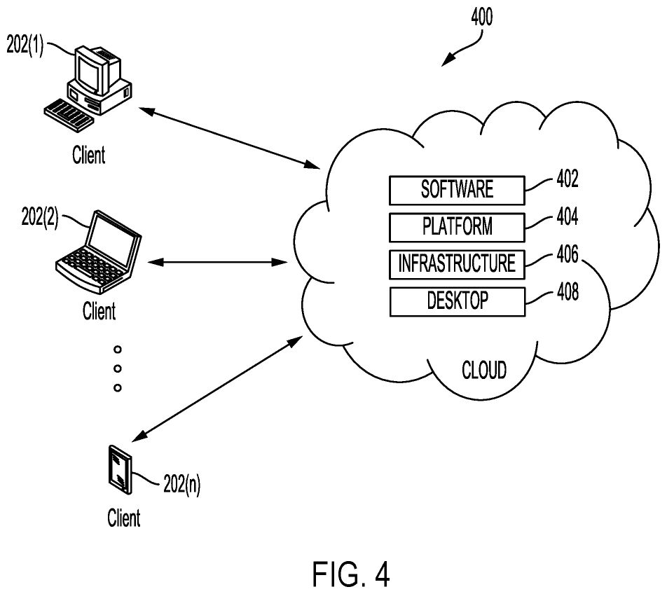

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tx., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif. Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

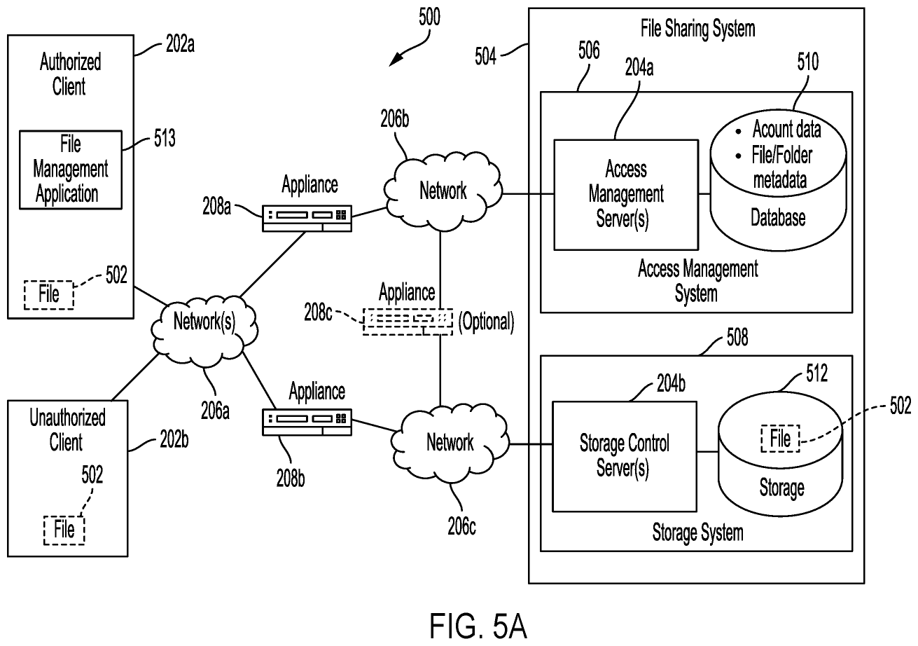

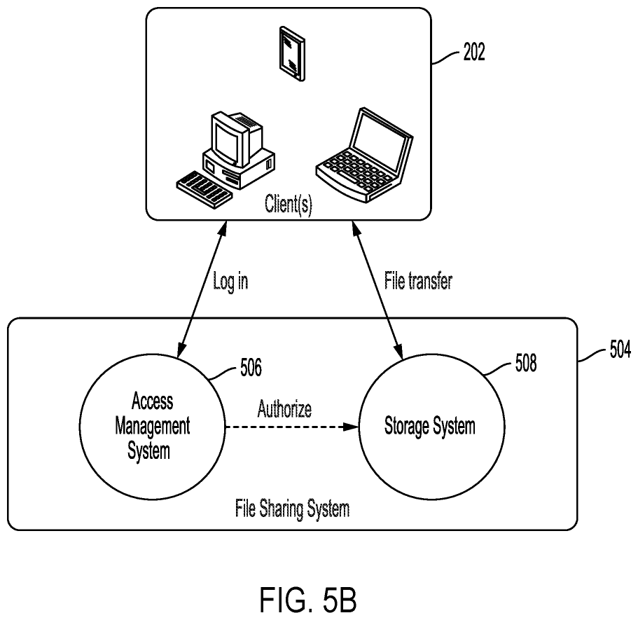

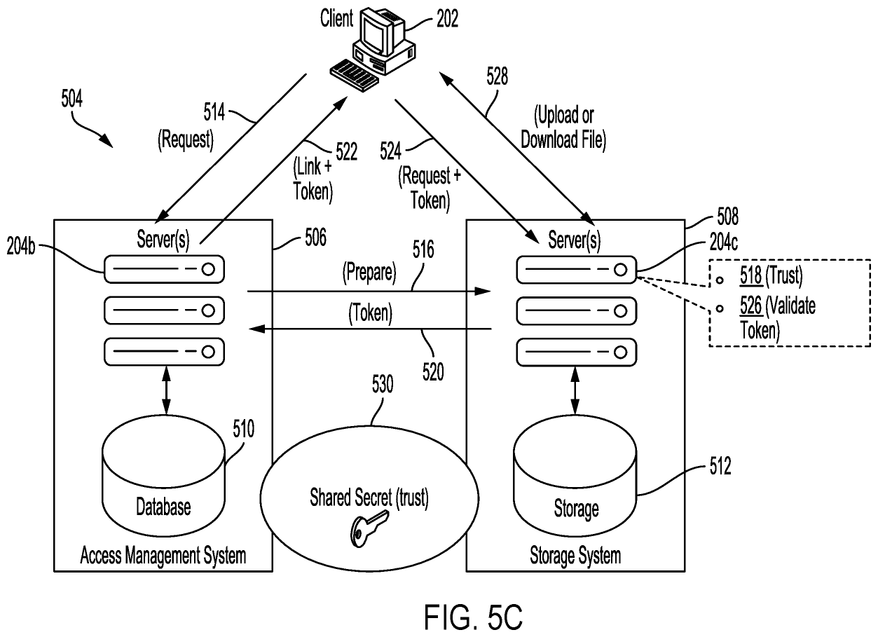

FIG. 5A shows an example network environment 500 for allowing an authorized client 202a and/or an unauthorized client 202b to upload a file 502 to a file sharing system 504 or download a file 502 from the file sharing system 504. The authorized client 202a may, for example, be a client 202 operated by a user having an active account with the file sharing system 504, while the unauthorized client 202b may be operated by a user who lacks such an account. As shown, in some embodiments, the authorized client 202a may include a file management application 513 with which a user of the authorized client 202a may access and/or manage the accessibility of one of more files 502 via the file sharing system 504. The file management application 513 may, for example, be a mobile or desktop application installed on the authorized client 202a (or in a computing environment accessible by the authorized client). The ShareFile® mobile app and the ShareFile® desktop app offered by Citrix Systems, Inc., of Fort Lauderdale, Fla., are examples of such preinstalled applications. In other embodiments, rather than being installed on the authorized client 202a, the file management application 513 may be executed by a web server (included with the file sharing system 504 or elsewhere) and provided to the authorized client 202a via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium 512. In some embodiments, the access management server(s) 204a may, for example, allow a user of the file management application 513 to log in to his or her account, e.g., by entering a user name and password corresponding to account data stored in the database 510. Once the user of the client 202a has logged in, the access management server 204a may enable the user to view (via the authorized client 202a) information identifying various folders represented in the storage medium 512, which is managed by the storage control server(s) 204b, as well as any files 502 contained within such folders. File/folder metadata stored in the database 510 may be used to identify the files 502 and folders in the storage medium 512 to which a particular user has been provided access rights.

In some embodiments, the clients 202a, 202b may be connected to one or more networks 206a (which may include the Internet), the access management server(s) 204a may include webservers, and an appliance 208a may load balance requests from the authorized client 202a to such webservers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202a, 202b are shown is FIG. 5A as stand-alone computers, it should be appreciated that one or both of the clients 202a, 202b shown in FIG. 5A may instead represent other types of computing devices or systems that can be operated by users. In some embodiments, for example, one or both of the authorized client 202a and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202a, 202b received from the network(s) 206a (which may include the Internet) to the storage control server(s) 204b. In some embodiments, the storage control server(s) 204b and/or the storage medium 512 may be hosted by a cloud-based service provider (e.g., Amazon Web Services™ or Microsoft Azure™). In other embodiments, the storage control server(s) 204b and/or the storage medium 512 may be located at a data center managed by an enterprise of a client 202, or may be distributed among some combination of a cloud-based system and an enterprise system, or elsewhere.

After a user of the authorized client 202a has properly logged in to an access management server 204a, the server 204a may receive a request from the client 202a for access to one of the files 502 or folders to which the logged in user has access rights. The request may either be for the authorized client 202a to itself to obtain access to a file 502 or folder or to provide such access to the unauthorized client 202b. In some embodiments, in response to receiving an access request from an authorized client 202a, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202a, and the authorized client 202a may then send a request for a file 502, including the token, to the storage control server(s) 202b. In other implementations, the authorized client 202a may send the generated token to the unauthorized client 202b so as to allow the unauthorized client 202b to send a request for the file 502, including the token, to the storage control server(s) 204b. In yet other implementations, an access management server 204a may, at the direction of the authorized client 202a, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202a to send a request to the URL address, or by sending an email, text message or other communication including the token-containing URL to the unauthorized client 202b, either directly from the access management server(s) 204a or indirectly from the access management server(s) 204a to the authorized client 202a and then from the authorized client 202a to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202a or an unauthorized client 202b to upload a file 502 to a folder corresponding to the token. In some embodiments, for example, an “upload” token can be generated as discussed above when an authorized client 202a is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user's that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

### F. Detailed Description of Example Embodiments of the File Transfer Systems and Methods Introduced in Section A

As discussed above in Section A in connection with FIGS. 1A and 1B, to efficiently transfer a file from the client device 106 to the server 102, the client device 106 may be able to avoid unnecessarily transferring one or more sections of the file to the server 102 by having the server 102 inform the client device 106 if one or more identical file sections are already present at the server 102. In particular, the client device 106 may send to the server 102 hashes that are generated using sections of the to-be-transferred file, and the server 102 may compare the received hashes with hashes that were generated using file sections already stored at the server 102. The server 102 may determine that a file section is already stored at the server 102 if a hash matching a received hash is found at the server 102.

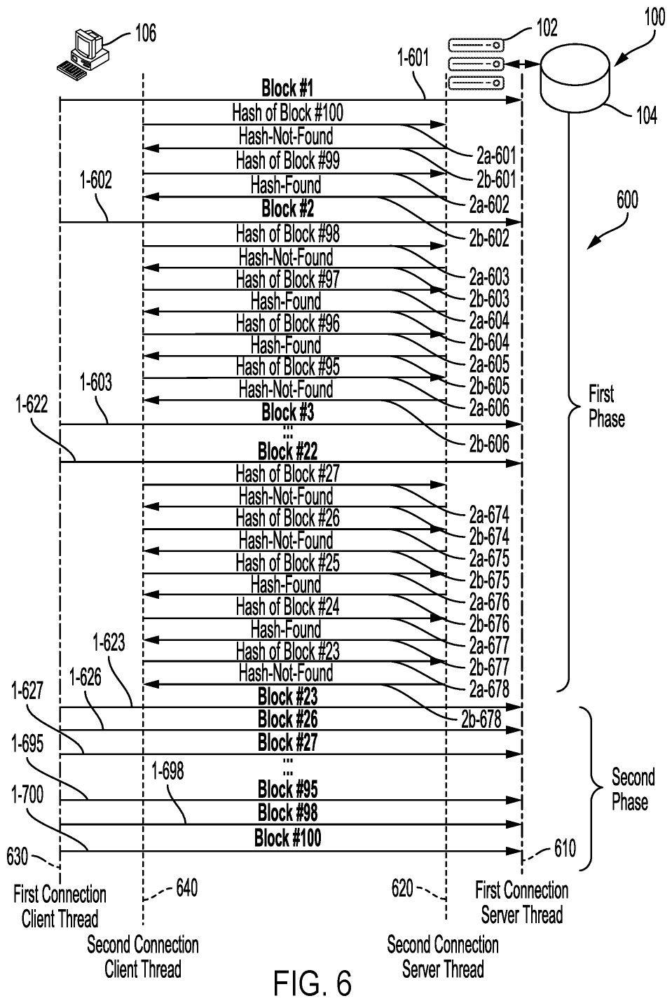

FIG. 6 shows a sequence diagram 600 for example data exchanges between the server 102 and the client device 106 during a file transfer, according to some embodiments. As shown in FIG. 6, in some implementations, the server 102 and the client device 106 may establish two connections and may transfer data though those connections via two corresponding threads. More specifically, as illustrated, the server 102 may establish a first connection server thread 610 to receive client file block data from a first connection client thread 630 through a first connection. Further, the server 102 may establish a second connection server thread 620 to receive hashes of client file blocks from, and send messages to, a second connection client thread 640 through a second connection.

Although the example implementation described below employs two separate connections for transferring file blocks and sending communications relating to hashes, respectively, it should be appreciated that multiple connections need not be employed in all circumstances and that, in other implementations, a single connection may be used for both purposes. In some implementations, for example, both types of communications may take place over the same connection, such as by using a time-sharing technique or other mechanisms to share the available bandwidth of the common connection for both purposes, i.e., for transferring file blocks and for communicating hashes and messages relating to the same. Alternatively, some implementations may employ more than two connections and, for example, use multiple connections for transferring the file blocks and/or for transferring the hashes.

Moreover, although the example implementation described below employs a separate thread for transferring data through each connection, in some embodiments the server 102 and the client device 106 may employ other mechanisms for exchanging data through one or more connections. Those mechanisms may include, for example, executing a single process on the server 102 and another single process on the client device 106 for exchanging data through the one or more connections.

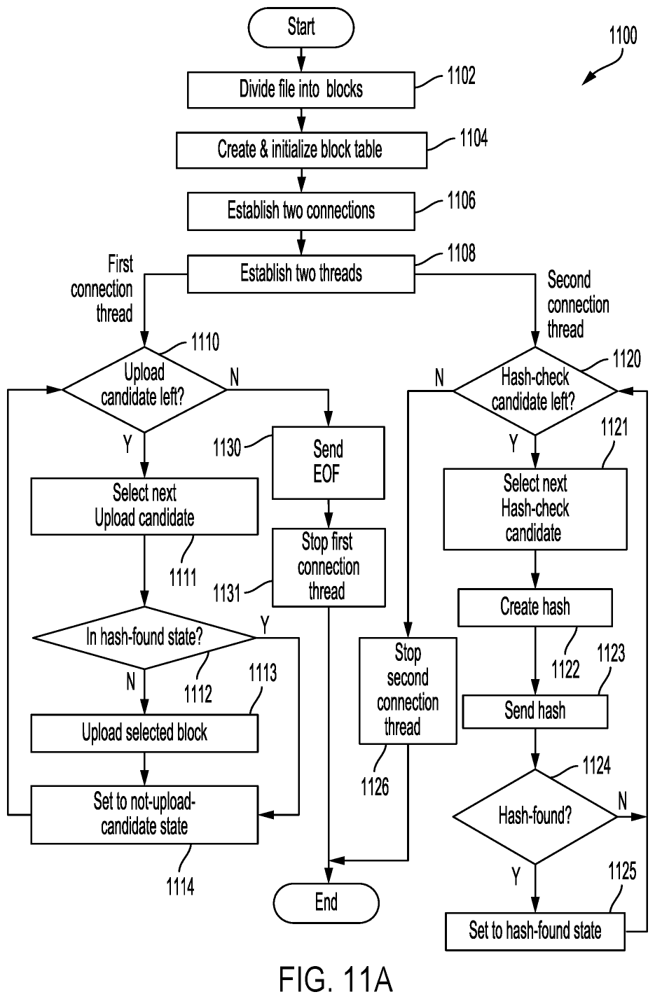

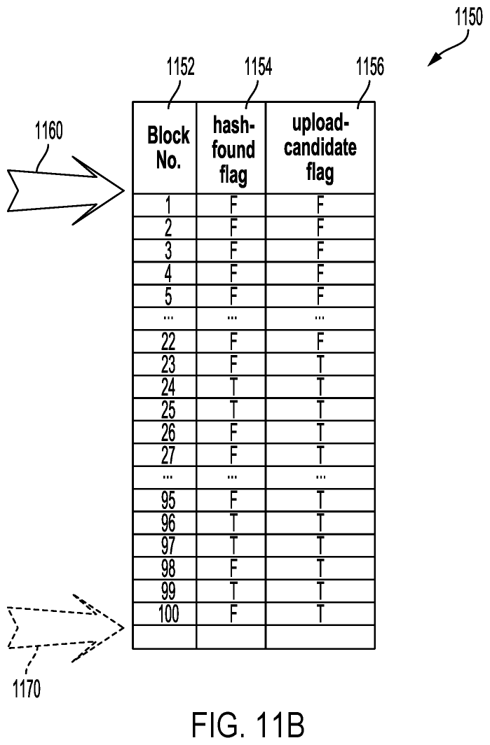

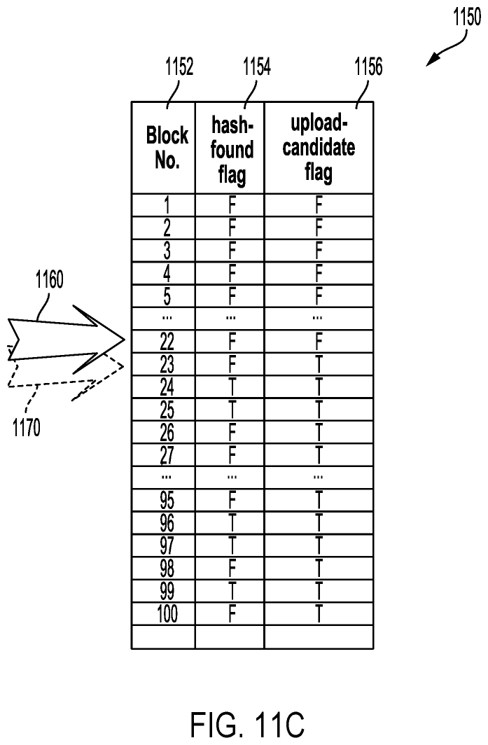

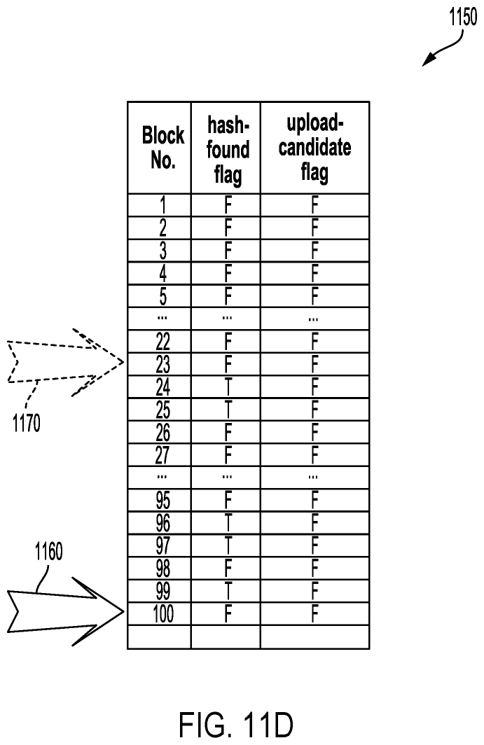

In the embodiment shown in FIG. 6 (and later described in connection with FIGS. 11B-11D), for illustrative purposes it is assumed that the client file is divided into one hundred blocks that are labelled with sequential numbers, e.g., as block #1, block #2, and so on up to block #100. Moreover, it is assumed that the first connection client thread 630 uploads the client file blocks by selecting the blocks in a sequential manner and in the order of increasing block number, starting from the first block (here block #1). Conversely, it is assumed that the second connection client thread 640 generates and transfers the hashes of client file blocks by selecting the blocks in the reverse order, also sequentially, starting from the last block (here block #100).

In various embodiments, the blocks may be labelled in other manners (e.g., with other types of alphanumeric labels) that may or may not be ordered. Moreover, the first and second connection client threads 630 and 640 may select the client file blocks in other manners, as explained further below.

In the sequence diagram 600, at a step 1-601, the first connection client thread 630 may select the client file block #1 and upload it by sending the data of block #1 (the “block data” for block #1) to the first connection server thread 610 through the first connection. The block data for the blocks that the first connection client thread 630 selects and sends in this and future steps (e.g., steps 1-602 to 1-623, 1-626, . . . ) may include, in addition to the content of the selected block (here block #1), some metadata of the selected block. The metadata may include data such as the address of the uploaded block in the client file. The server 102 may utilize the received metadata to place the contents of the blocks in the correct order for recreating a server copy of the client file. The server 102 may store the received block data or the server copy of the client file in the storage medium 104.

While the upload of block #1 (at the step 1-601) is in progress (hereafter alternatively called the “upload interval” for block #1), the second connection client thread 640 may select and process one or more other client file blocks as detailed next in descriptions of steps 2a-601, 2b-601, 2a-602 and 2b-602. In the illustrated example, two such other client file blocks are processed.

At the step 2a-601, the second connection client thread 640 may select block #100, generate a hash for that block, and send (upload) the data for the generated hash (the “hash data” for block #100) to the second connection server thread 620 through the second connection. The hash data that the second connection client thread 640 sends in this and future steps (e.g., steps 2a-602 to 2a-678, described below) may include, in addition to the content of the hash (the content of the hash sometimes being alternatively called the hash content or simply called the hash), some metadata of the selected block (here block #100), in the manner explained above for step 1-601 for the metadata of block #1.

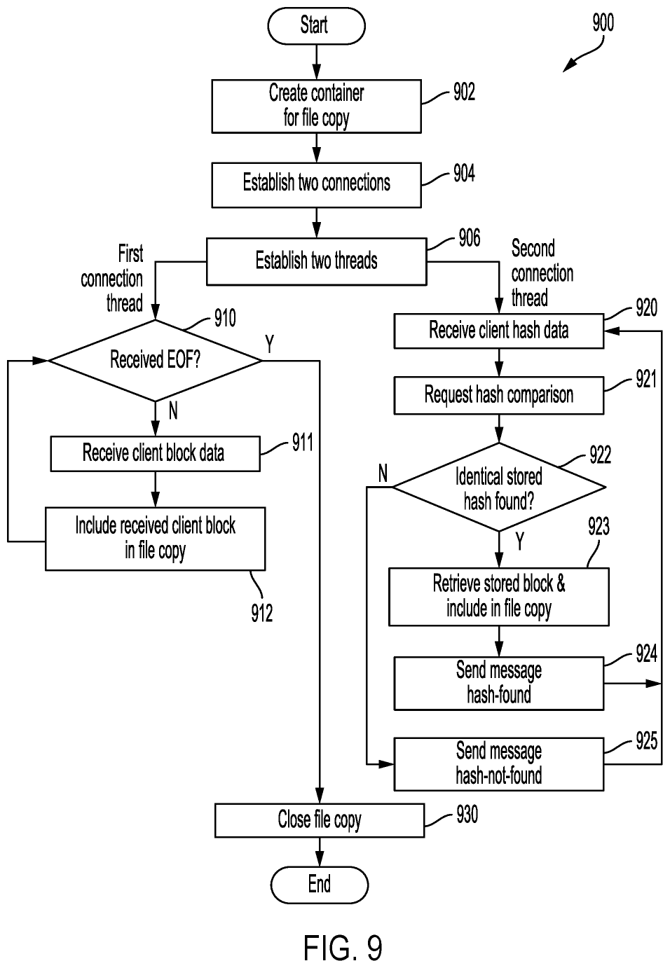

In response to receiving the hash data for block #100 (at the step 2a-601), the second connection server thread 620 may analyze the received hash data in a manner detailed below (e.g., in connection with the detailed description of FIG. 9) and, at a step 2b-601, may send a reply message to the second connection client thread 640, indicating either that the server 102 has found a stored hash that is identical to the hash of the selected client block (a “hash-found message”) or that the server 102 has not found such a stored hash (a “hash-not-found message”). In different embodiments the hash-found and hash-not-found messages may be of different formats. In some embodiments, the hash-found and hash-not-found messages may be, for example, in the form of texts (including, e.g., the strings “hash-found” and “hash-not-found”, respectively), while in other embodiments they may be logical variables (with, e.g., values of true and false, respectively) or binary variables (with, e.g., values of 0 and 1, respectively), etc.

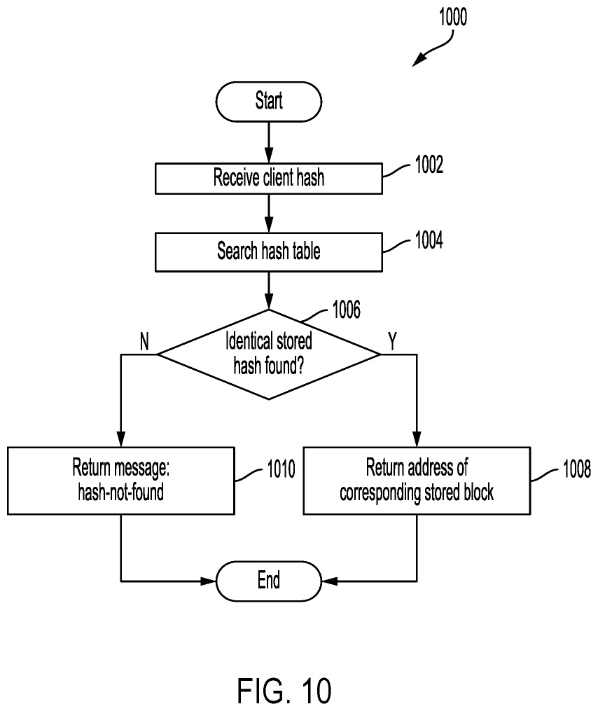

In the illustrative example of FIG. 6, the message from the server 102 (per the step 2b-601) is a hash-not-found message, indicating that the server 102 has not found a stored hash identical to the hash of client block #100. Similarly, the respective ensuing reply messages from the second connection server thread 620 to the second connection client thread 640 (i.e., per steps 2b-602 to 2b-678) are either a hash-found message or a hash-not-found message (as further explained in the description of those steps). In various embodiments, the hash-found or hash-not-found messages may appear in any other order based on conditions that will be described below in, for example, the detailed description of FIGS. 9 and 10.

The second connection client thread 640 may store the indication in the reply message of the step 2b-601 for use by the client device 106 as further detailed below in, for example, the description of steps 1-623 to 1-700, and the detailed description of FIG. 11A.

After completion of the step 2b-601, at a step 2a-602 of the sequence diagram 600, the second connection client thread 640 may select block #99, generate a hash for that block, and send the hash data for block #99 to the second connection server thread 620 through the second connection. The second connection server thread 620 may analyze the received hash data and, at a step 2b-602, may send a hash-found message to the second connection client thread 640, indicating that the server 102 have found a stored hash that is identical to the hash of client block #99. The second connection client thread 640 may also store this and future indications for use by the client device 106.

While the second connection threads (of the client device 106 and the server 102) perform the above steps (steps 2a-601, 2b-601, 2a-602 and 2b-602), the first connection threads may complete the step 1-601, by completing uploading of block data for block #1, thus ending the upload interval for block #1. The first connection thread pair (610, 630) may then proceed to a step 1-602 of the sequence diagram 600 by selecting and starting to upload block data for block #2 from the client device 106 to the server 102.

During the upload interval for block #2, per the step 1-602, the second connection client thread 640 may select and process one or more additional client file blocks as detailed next in descriptions of steps 2a-603 to 2a-606 and steps 2b-603 to 2b-606. Four such additional client blocks are processed in the illustrated example.

At the steps 2a-603 to 2a-606 of the sequence diagram 600, the second connection client thread 640 may select, generate hashes, and send the hash data for blocks #98, #97, #96, and #95 respectively. In response to receiving the hash data per these four steps, in the following steps (i.e., steps 2b-603 to 2b-606, respectively), the second connection server thread 620 may analyze the received hash data and send a hash-found or a hash-not-found message. More specifically, per the steps 2b-603 and 2b-606, the second connection server thread 620 may send respective hash-not-found messages for the client blocks #98 and #95. At the steps 2b-604 and 2b-605, on the other hand, the second connection server thread 620 may send respective hash-found messages for the client blocks #97 and #96. The second connection client thread 640 may store these indications for use by the client device 106.

While the second connection thread pair (620, 640) performs the above steps (per the steps 2a-603 to 2a-606 and steps 2b-603 to 2b-606), the first connection thread pair (610, 630) may complete uploading block #2, and may then proceed to a step 1-603 of the sequence diagram 600 and start uploading block data for block #3 from the client device 106 to the server 102.

As further shown in FIG. 6, at the steps 1-603 to 1-622, the first connection client and server threads 610 and 630 may continue transferring, through the first connection, block data for blocks #3 to #22 from the client device 106 to the server 102. Further, as also shown in FIG. 6, at the steps 2a-606 to 2a-678, the second connection client thread 640 may continue transferring, through the second connection, hash data for blocks #95 to block #23 (in reverse order), and may receive, also through the second connection, indications as to whether or not the server 102 has found identical hashes, and store those indications.

After completion of processing block #23, per the steps 2a-678 and 2b-678, the second connection client thread 640 may select the next block for processing, i.e., block #22, and may determine that the block data for block #22 has already been uploaded by the first connection thread pair (610, 630), as explained above in relation to the step 1-622. Upon this determination, the client device 106 may stop the second connection client thread 640. Examples of mechanisms for making this determination and stopping of the second connection client thread 640 are further explained in, for example, the detailed descriptions of FIG. 11A. Upon stopping of the second connection client thread 640, the first connection thread pair (610, 630) may continue and complete the uploading of the file as further explained below in, for example, the descriptions of steps 1-623 to 1-700, and the detailed description of FIG. 11A.

In some implementations, as indicated in FIG. 6, the whole period of the uploading may thus be divided into two phases. A first phase may start with uploading and end with the stopping of the second connection client thread 640. A second phase, on the other hand, may start upon the completion of the first phase and end upon the completion of the uploading. During the first phase, both connections may be used, the first connection for transferring the block data, and the second connection for transferring the hash data and the reply messages from the server 102. In the embodiment of FIG. 6, the first phase starts at the start of the sequence diagram 600, and ends at the completion of the step 2b-678. During the second phase, on the other hand, the second connection is not used and only the first connection is used for transferring the block data, in the manner that follows. In the embodiment of FIG. 6, the second phase starts after the completion of the step 2b-678, with the step 1-623, and ends upon completion of the sequence diagram 600.

In various embodiments, the uploading operations may be performed in other manners and not in two phases as explained here, or the phases may be defined differently. For example, in some embodiments, both connections may be active throughout the uploading. During the uploading, for instance, the client device 106 may use the second connection for transferring the hash data for the blocks and, upon receiving a hash-not-found message, use the first connection for transferring the block data for the corresponding block.

During the second phase, which in FIG. 6 starts at the step 1-623, the first connection client thread 630 may continue selecting the client file blocks in a continuation of the order it used in the first phase, i.e., in this case in an increasing sequential order starting from block #23. In subsequent steps, the first connection client thread 630 may first make a determination as to whether or not the second connection client thread 640 has already stored a hash-found indication for the selected block. If the answer is affirmative, the first connection client thread 630 may skip uploading block data for the selected block and may proceed to selecting the next client file block. Otherwise, the first connection client thread 630 may upload the block data for the selected block through the first connection before proceeding to selecting the next block. The sequence diagram 600 shows only the steps that include data transmission through one of the two connections, which is the first connection in the second phase. Those steps are described next. More details, including the mechanism for the determination as to whether or not the second connection client thread 640 has already stored a hash-found indication for the selected block, are provided below in, for example, the detailed description of FIG. 11.

Based on the above-described process of the second phase, per the step 1-623, the first connection client thread 630 may select block #23, determine that the second connection client thread 640 has already stored a hash-not-found indication for block #23 (as shown in the step 2b-678), and proceed to uploading the block data for block #23.

After completion of the upload interval for block #23, per the step 1-623, the first connection client thread 630 may select block #24, determine that the second connection client thread 640 has already stored a hash-found indication for block #24, as shown for step 2b-677, skip uploading block data for block #24, and proceed to selecting the next block, i.e., block #25. A similar process as just described may then be performed for block #25, such that the first connection client thread 630 may likewise skip uploading block #25 in response to identifying a hash-found indication for that block (stored per the step 2b-676).

At steps 1-626 and 1-627, respectively, the first connection client thread 630 may select block #26 and block #27, determine that the second connection client thread 640 has already stored indications that identical hashes have not been found on the server 102 for the hashes of those blocks, as shown for steps 2b-675 and 2b-674, and proceed to uploading the block data for block #26 and block #27.

In the remainder of the second phase, the first connection client thread 630 may select respective blocks #28 to block #100, and either skip or perform uploading block data for the selected block, based on whether a hash-found or a hash-not-found indication has been stored for the selected block. In particular, as shown for the end of the second phase in the sequence diagram 600 of FIG. 6, at steps 1-695, 1-698, and 1-700, the first connection client thread 630 may upload block data for blocks #95, #98, and #100 based on hash-not-found messages received at steps 2b-606, 2b-603, and 2b-601, respectively. Moreover, between steps 1-695 and 1-700, the first connection client thread 630 may skip uploading block data for blocks #96, #97, and #99 based on hash-found messages received at steps 2b-606, 2b-603, and 2b-601, respectively.

Various details of the sequence diagram 600 may change in different implementations. For example, in the first phase, the number of hashes that are uploaded by the second connection thread pair (620, 640) during the upload interval of a block may be the same or may be different for upload intervals of different blocks. In the implementation shown in FIG. 6, for example, the number of uploaded hashes during the upload intervals for blocks #1, #2, and #22 (per the steps 1-601, 1-602, and 1-622, respectively) are respectively two, four, and five. In different embodiments, or in different upload intervals within the same embodiment, those numbers may depend, for example, on the bandwidth allocated to the respective connections, the sizes of the blocks (which may be vary among different embodiments), the sizes of the hashes, the sizes of the metadata, the processing speeds of the threads, etc.

Moreover, in some implementations, the client threads for the two connections may select the blocks in different ways. In some implementations, such as that shown in FIG. 6, the total upload time may be divided into two phases: during the first phase, both first and second connection client threads may be in operation by selecting from, respectively, a first subset (here blocks #1 to #22) and a second subset (here blocks #23 to #100) of the blocks to which the client file is divided, and uploading data related to the selected block through their respective connections; while during the second phase, one of the two client threads (tentatively the second connection client thread) may stop its operation and the other client thread (tentatively the first connection client thread) may continue its operation by selecting blocks and uploading data related to the selected block through its connection. In some implementations, during the second phase, the first connection client thread 630 may select some or all blocks in the second subset.

Further, in various implementations, the two subsets may be disjointed, as is the case in the example implementation shown in FIG. 6, or may have some non-empty overlap, as further detailed below in relation to FIG. 11A. Moreover, in some implementations, as with the example implementation shown in FIG. 6, the union of the two subsets may be all of the blocks.

Further, different implementations may use different criteria for selecting the blocks in respective subsets or the order in which they are selected. In some implementations, for example, the first connection client thread 630 may select the members of the first subset using a first criterion (here in the order of increasing block number starting from the first block, block #1), while the second connection client thread 640 may select the second subset using a second criterion (here in the reverse order starting from the last block, block #100). Moreover the different threads may end the selections of the members of the two subsets (and end the first phase) when the respective subsets together form a partition of the set of all blocks. In some implementations, the different threads may select the members of the respective subsets based on other criteria. For example, a client device 106 may assess the probability that the hash of a block may be found by the server 102 and accordingly may select the members of the second subset from those blocks with a higher probability of being found by the server 102. The client device 106 may, for example, assess the probability based on a similarity between the type of the data in a block (e.g., numerical, text, image, etc.) of the client file and the abundance or quantity of that type of data among the block stored by the server 102.

Moreover, in various embodiments, the different threads on server 102 or on client device 106 may perform their operations and send data in parallel, serially, by time sharing, etc.

Different parts of the above operations may be performed by different components of the file transfer system 100, as further detailed below.

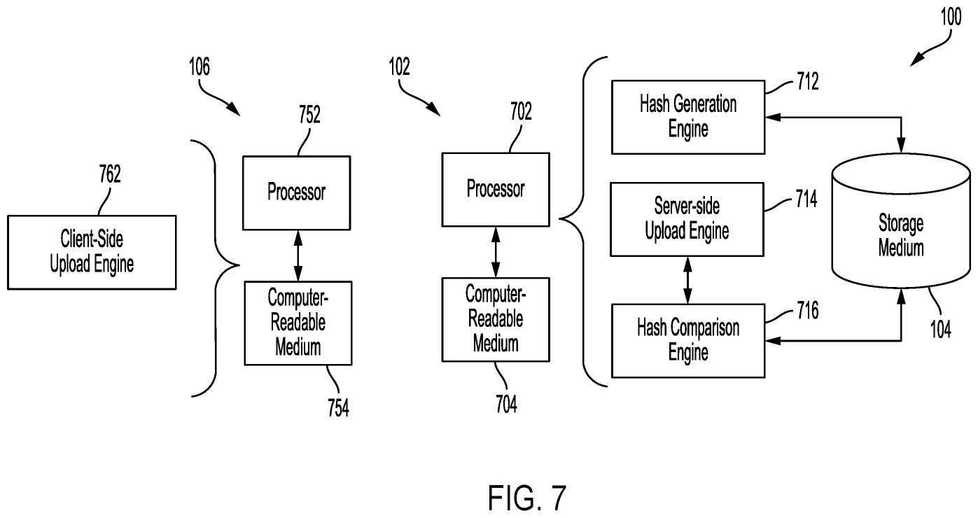

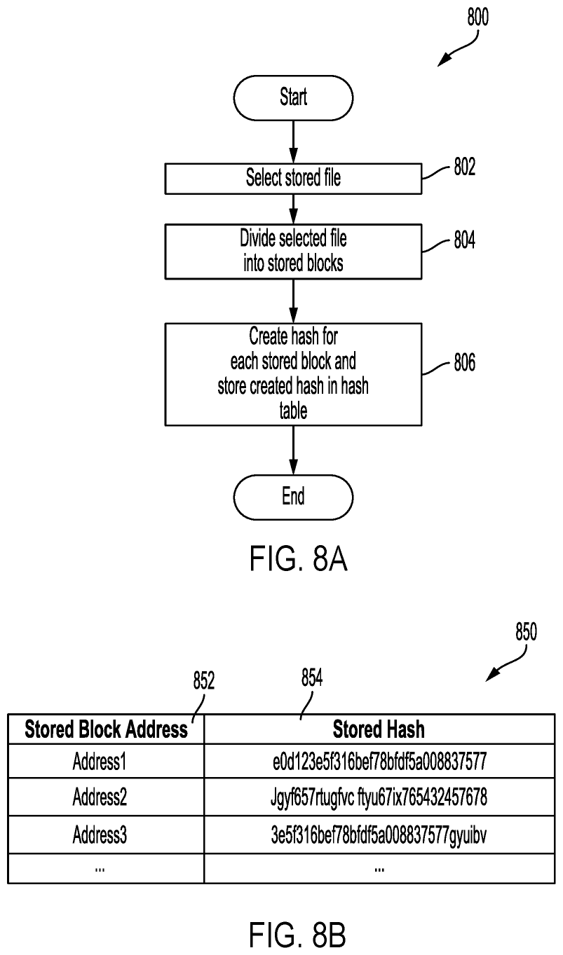

FIG. 7 shows example components of the file transfer system 100 that was introduced above (in Section A) in connection with FIGS. 1A and 1B. As shown in FIG. 7, in addition to the storage medium 104 (also shown in FIGS. 1A and 1B), the server 102 may include one or more processors 702 (hereafter alternatively called “the processor 702”) and one or more computer-readable mediums 704 (hereafter alternatively called “the computer-readable medium 704”) that may be encoded with instructions that can be executed by the processor 702 to cause the server 102 to perform various routines (e.g., the routines 150 and 160 shown in FIGS. 1A and 1B, respectively). In the illustrated example, the processor 702 and the computer-readable medium 704 embody three functional modules, including a hash generation engine 712, a server-side upload engine 714, and a hash comparison engine 716. Some details of functionalities and operations of the engines 712, 714, and 716 are described in the detailed descriptions of FIGS. 8 (8A and 8B), 9, and 10, respectively.

Further, as also shown in FIG. 7, the client device 106 may also include one or more processors 752 (hereafter alternatively called “the processor 752”) and one or more computer-readable mediums 754 (hereafter alternatively called “the computer-readable medium 754”) that may be encoded with instructions that can be executed by the processor 752 to cause the client device 106 to perform various routines (e.g., as shown in FIGS. 1A and 1B). In the illustrated example, the processor 752 and the computer-readable medium 754 embody one functional module, a client-side upload engine 762. Some details of functionalities and operations of the client-side upload engine 762 are described in the detailed description of FIGS. 11A and 11B.

The engines 712, 714, and 716 of the server 102 may be implemented in any of numerous ways and may be disposed at any of a number of locations within a computing network, such the network environment 200 described above (in Section B) in connection with FIG. 2. In some implementations, for example, the processor 702 and the computer-readable medium 704 embodying one or more such components may be located within one or more of the servers 204 and/or the computing system 300 that are described above (in Sections B and C) in connection with FIGS. 2 and 3, and/or may be located within a cloud computing environment 400 such as that described above (in Section D) in connection with FIG. 4.

In some implementations, the server-side upload engine 714 shown in FIG. 7 may correspond to, or operate in conjunction with, the storage control server 204b of the file sharing system 504 described above (in Section E) in connection with FIGS. 5A-C. Further, in some implementations, the storage medium 104 shown in FIGS. 1A-B and 7 may correspond, in whole or in part, to the storage medium(s) 512 of the storage system 508 described in Section E. As Section E explains, in some implementations, the storage control server 204b of the storage system 508 may cause copies of files 502 to be transferred between client devices 202 and the storage medium(s) 512. In particular, in some implementations, as described in connection with FIG. 5C, the access management system 506 may supply upload tokens to the client devices 202 that may be used to identify the particular folders in the storage medium(s) 512 that new files 502 the storage control server(s) 204c receive from the client devices 202 are to be uploaded and/or may supply download tokens to the client devices 202 that may be used to identify the particular files 502 that the storage control server(s) 204c are to download to the client devices 202.

In some implementations, the hash generation engine 712 may generate hashes for file blocks stored in the storage medium 104, and may store those hashes and the related data in the storage medium 104. An example hash table 850 that may be used to store such data in accordance with some embodiments of the present disclosure is described below in connection with FIG. 8B. Also, an example routine 800 that may be executed by the hash generation engine 712 is described below in connection with FIG. 8A.

In some implementations, the server-side upload engine 714 may, among other things, receive a client hash from the client device 106, and send the client hash to the hash comparison engine 716. In some implementations, upon receiving the client hash from the server-side upload engine 714, the hash comparison may determine whether or not an identical hash exits among the hashes stored in the storage medium 104. Based on the outcome of that determination, the server-side upload engine 714 may either request the client device 106 to send the block of the client file for which the received hash was generated, or retrieve a stored block for which the identical stored hash was generated. The server-side upload engine 714 may further include the received block or the retrieved block in a copy of the client file the server 102 is creating. Examples of routines 900 and 1000 that may be executed by the server-side upload engine 714 and the hash comparison engine 716, respectively, are described below in connection with FIGS. 9 and 10.

In some implementations, the client-side upload engine 762 may, among other things, establish one or more connections, and exchange data with the server-side upload engine 714, in a manner similar to what was discussed above in the detailed description of FIG. 6. In particular, the client-side upload engine 762 may identify a file to be uploaded, divide the file into blocks of data, and generate hashes for some of the blocks. Further, the client-side upload engine 762 may send hash data and block data to the server-side upload engine 714, and may receive and store hash-found or hash-not-found messages from the server-side upload engine 714, in a manner similar to what was discussed above in the detailed description of FIG. 6.

In some implementations, the client-side upload engine 762 may write, or read, data related to the blocks and/or the corresponding hash-found and hash-not-found messages in a block table stored in a storage medium that is accessible to the client device 106. An example block table 1150 that may be used to store such data in accordance with some embodiments of the present disclosure is described below in connection with FIGS. 11B-11D. Also, an example routine 1100 that may be executed by the client-side upload engine 762 is described below in connection with FIG. 11A.

FIG. 8A is a flowchart showing an example routine 800 that may be performed by the hash generation engine 712 shown in FIG. 7, according to some embodiments. Moreover, FIG. 8B shows the example hash table 850 that may be populated by the hash generation engine 712, and utilized by at least the hash comparison engine 716, according to some embodiments.

As shown in FIG. 8A, the routine 800 may begin at a step 802, at which the hash generation engine 712 may select a file that is accessible to the server 102, and may process the selected file in the manner shown in the ensuing steps of the routine 800, described below. The selected file may be, for example, a file that is stored in the storage medium 104. The hash generation engine 712 may select the file in any of a number of ways. For example, in some implementations, a file selector routine (not shown) may select the file and send the addresses of the selected file to the hash generation engine 712. Such a file selector routine may use one or more methods for selecting the file. For example, the file selector routine may periodically, or otherwise, scan the storage medium 104 and select files that have not been previously processed by the hash generation engine 712. Alternatively or additionally, the file selector routine may select a file when the file is being stored in the storage medium 104 for the first time. In some implementations, such a file selector routine may be performed by the hash generation engine 712 or by one or more other functional components of the server 102.

After file selection, at a step 804 of the routine 800, the hash generation engine 712 may divide the selected file into one or more file sections. In some embodiments, the file sections may be blocks of equal size. In some implementations, for example, the size of respective blocks may be one kilobyte (KB), i.e., 1024 bytes. The hash generation engine 712 may further store content and/or identifiers of the respective file sections (e.g., blocks) in, for example, the storage medium 104.

At a step 806 of the routine 800, the hash generation engine 712 may generate hashes for the file sections identified at the step 804 and may store those hashes in a hash table, for example, the hash table 850 shown in FIG. 8B. In some embodiments, the hash generation engine 712 may combine steps 804 and 806, such that, after identifying a file section (e.g., a block), the hash generation engine 712 may generate and store the hash for the file section, before it proceeds to identifying the next file section.

FIG. 8B shows an example of the hash table 850 in which the hash generation engine 712 may store the generated hashes and other data for the identified file sections (e.g., blocks), according to some embodiments. In the hash table 850, respective rows may correspond to the data for one of the identified file sections (e.g., blocks). As shown, in some implementations, the hash table 850 may include two columns, columns 852 and 854. The column 852 may, for example, include identification data that the server 102 can use to find the stored block. In some embodiments, for example, the identification data in column 852 may include an address of the block in a storage medium, for example, in the storage medium 104. Column 854, on the other hand, includes the hash generated for the corresponding block. In some embodiments, the hash of a block may be generated by applying a hashing method to the content of the block. The hashing method may be, for example, one of the MD5, MD6, SHA-1, or SHA-256 methods. In various embodiments, the hash value may be other types of values that are generated by other methods and to which the contents of the blocks are mapped. In some embodiments, the sizes of different hashes may be the same. The hash table 850 may be used by the server-side upload engine 714, as further detailed below.

FIG. 9 is a flowchart showing an example routine 900 that may be performed by the server-side upload engine 714 shown in FIG. 7, according to some embodiments. As detailed below, during the routine 900, the server-side upload engine 714 may receive data from the client-side upload engine 762 and, using the received data, may create a copy of a client file.

More specifically, as shown in FIG. 9, the routine 900 may begin at a step 902, at which the server-side upload engine 714 may create a container for the copy of the client file to be generated. Creating the container may include one or more steps such as assigning to the copy of the client file a fixed size or a variable size storage (e.g., in the form of assigned blocks), one or more addresses in the storage, a starting address, etc.

At a step 904 of the routine 900, the server-side upload engine 714 may establish two connections with the client-side upload engine 762, such as the first and second connections discussed above in relation to FIG. 6. Further, at a step 906 of the routine 900, the server-side upload engine 714 may establish two threads for exchanging data via the two connections. The two threads may be, for example, the first and second connection server threads 610 and 620 described above in connection with FIG. 6. As FIG. 9 illustrates, following the step 906, the routine 900 may split into two portions corresponding the first and second connection threads, with the first portion (performed by the first connection server thread 610) including steps 910 through 912, and the second portion (performed by the second connection server thread 620) including steps 920 through 925.

At a decision step 910 of the first connection server thread 610, the server-side upload engine 714 may determine whether it has received an end-of-file (EOF) indication from the client device 106. In some implementations, for example, the client-side upload engine 762 may send such an EOF indication to the server-side upload engine 714 after the client-side upload engine 762 determines (e.g., per a decision step 1110—shown in FIG. 11A) that it has completed the transfer of the file sections that the server 102 does not already have in storage.

When, at the decision step 910, the server-side upload engine 714 determines that an EOF indication has not been received (the decision step 910: N), the routine 900 may proceed to a step 911, described below. When, on the other hand, the server-side upload engine 714 determines (at the decision step 910) that an EOF indication has been received (the decision step 910: Y), the routine 900 may instead proceed to a step 930, at which the server-side upload engine 714 may determine that the copy of the client file it has been creating is complete and may thus close the copy of the client file. Following the step 930, the copy of the client file may be stored in the storage medium 104 and may thereafter be accessed by the server 102 as needed.

At a step 911 of the first connection server thread 610, the server-side upload engine 714 may receive client block data from the client-side upload engine 762 (e.g., as sent by the client-side upload engine 762 per a step 1113 of the routine 1100—described below).

At a step 912 of the first connection server thread 610, the server-side upload engine 714 may include the newly-received client block in the container for the copy of the client file the server-side upload engine 714 is creating. As indicated previously, in some implementations, client blocks sent to the server-side upload engine 714 may be accompanied by metadata indicating positions of the transmitted blocks within the client file, thus enabling the server-side upload engine 714 to determine appropriate locations for the newly-received client blocks within the copy it is creating.

The first connection server thread 610 may then loop back to the decision step 910. This looping of the first connection server thread 610 through the steps 910-912 may thus continue throughout the first and second phases introduced above in relation to FIG. 6 and further discussed below, in relation to FIGS. 11A-11D.

Referring next to the second connection server thread 620 of the routine 900, as explained below, that thread may perform a “client-hash processing” operation (per steps 920 through 925). As shown, the second connection server thread 620 may begin at a step 920, at which the server-side upload engine 714 may receive hash data for a client block from the second connection client thread 640. As explained above in connection with FIG. 6, the hash data may include the content of a hash generated for the client block as well as some metadata of the client block.

The second connection server thread 620 may then proceed to a step 921, at which it may send the received hash to the hash comparison engine 716 shown in FIG. 7, thus requesting a hash comparison. In some embodiments, the second connection server thread 620 may, in addition to sending the received hash, explicitly send a hash comparison request.

An example routine 1000 that may be performed by the hash comparison engine 716 will now be described, with reference to FIG. 10, before returning to FIG. 9 for a description of the remaining steps 922 through 925 of the second connection server thread 620. FIG. 10 is a flowchart showing an example routine 1000 that may be performed by the hash comparison engine 716 upon receiving the hash from the second connection server thread 620 of the server-side upload engine 714, according to some embodiments.

As shown in FIG. 10, the routine 1000 may begin at a step 1002, at which the hash comparison engine 716 may receive the hash along with, or without, receiving the hash comparison request. The hash comparison engine 716 may then proceed to a step 1004, at which it may search a hash table for a stored hash that is identical to received hash. In some embodiments, the searched hash table may be the hash table 850 populated by the hash generation engine 712 and discussed above in the detailed description of FIG. 8B. In some embodiments, such as those discussed in relation to FIG. 8B, the hash table 850 may contain hash data for stored hashes that may be generated for file blocks that are accessible to the server 102 by, for example, being stored in the storage medium 104.

Next, during the step 1004, the hash comparison engine 716 may search the hash table for a stored hash that is identical to the hash received from the server-side upload engine 714. In particular, the hash comparison engine 716 may compare the received hash with some or all of the stored hashes, e.g., the hashes listed in the column 854 of the hash table 850 (shown in FIG. 8B). The hash comparison engine 716 may use different techniques to maximize the search or minimize the search time. In some embodiments, for example, it may use data structures such as a radix tree for storing the data in the table 850 to facilitate the search. Further, in some embodiments, the hash comparison engine 716 may optimize the overall speed by performing partial searches, for example, searching part, and not all, of the table 850 for an identical stored hash. In such embodiments, unless the hash comparison engine 716 finds an identical stored hash during the partial search, it may return a hash-not-found message (discussed below in relation to a step 1010). In some implementations, the time thus saved by not performing a full search for every received hash may exceed the possible waste of time spent on uploading some received hashes, if any, for which the partial search does not turn up an identical stored hash (and thus will be uploaded), but a full search would turn up an identical stored hash (and would save the uploading time for those received hashes). In a partial search, the hash comparison engine 716 may, for example, limit the search to a subset of the rows of the hash table 850. The subset of rows may be the rows for which the probability of finding an identical hash is higher than a threshold probability (e.g., 50%). The hash comparison engine 716 may calculate or estimate those probabilities based on, for example, a similarity or dissimilarity between the data types (e.g., text, binary, image, etc.) for the uploaded file and the stored sections.

The hash comparison engine 716 may complete the search at the step 1004 when it finds a stored hash that is identical to the received hash (hash-found case) or when it finishes the comparison with the stored hashes, e.g., the hashes in the hash table 850, without finding such an identical hash (hash-not-found case).

The hash comparison engine 716 may then proceed to a decision step 1006, at which it may determine whether or not such an identical hash has been found among the stored hashes, e.g., the hashes in the hash table 850.

When the answer at the decision step 1006 is affirmative (the decision step 1006: Y), that is, when the hash comparison engine 716 determines that an identical hash has been found (hash-found case), the hash comparison engine 716 may proceed to a step 1008, at which it may return a hash-found message (indicating a hash-found case) and the identification data of a stored block for which the identical hash was generated. In some embodiments, such as that described in connection with FIG. 8B, the identification data may include an address of the stored block, for example, stored in column 852 of hash table 850 in the same row as the identical hash. In some embodiments, the hash comparison engine 716 may not return a hash-found message. In such cases, the receipt of the identification data may be interpreted, for example by the second connection server thread 620 of the server-side upload engine 714, to imply a hash-found case.

When the answer at the decision step 1006 is negative (the decision step 1006: N), that is, when the hash comparison engine 716 determines that an identical hash has not been found (hash-not-found case), the hash comparison engine 716 may proceed to the step 1010, at which it may return a hash-not-found message (indicating a hash-not-found case). In a partial search, for example, a hash-not-found case may not necessarily indicate that an identical hash does not exist in the hash table 850, but instead may indicate that an identical hash has not been found among the hashes in the subset of the rows that the hash comparison engine 716 may have selected for the partial search.

Returning to FIG. 9, and in particular to the client-hash-processing performed by the server-side upload engine 714, at a decision step 922 of the second connection server thread 620, the server-side upload engine 714 may receive the message sent by the hash comparison engine 716 (as discussed above in relation to FIG. 10), and may determine whether or not the hash comparison engine 716 has found a stored hash that is identical to the client hash sent in the step 920.

When the answer at the decision step 922 is affirmative (the decision step 922: Y), the message received from the hash comparison engine 716 may include the identification data of the stored block for which the identical hash was generated (as discussed above in relation to step 1008 of routine 1000 of FIG. 10). In this case, the second connection server thread 620 may proceed to a step 923, at which the server-side upload engine 714 may use the identification data (e.g., the address) of the stored block to retrieve the stored block. Moreover, the server-side upload engine 714 may include the retrieved stored block in the file copy it is creating. In some implementations, for example, the server-side upload engine 714 may use the metadata of the client block that it received at the step 920, to place the stored block at the correct location in the container.

The second connection server thread 620 may then proceed to a step 924, at which the server-side upload engine 714 may send a hash-found message to the second connection client thread 640 through the second connection as discussed above in relation to FIG. 6. The second connection server thread 620 may then loop back to step 920.

In some implementations, during the uploading, the server-side upload engine 714 may check for a possible hash collision. A hash collision may occur, for example, when a stored hash is identical to a client hash, but the corresponding stored block and client block are not identical. The server-side upload engine 714 may, in some implementations, check for a possible hash collision as follows. After including a plurality of blocks in the file copy, when the plurality of blocks includes one or more stored blocks (resulting from respective hash-found cases), the server-side upload engine 714 may generate a first hash for the plurality of blocks and compare it with a second hash generated for the corresponding plurality of blocks in the client file (the second hash having been generated, for example, by the client-side upload engine 762). When the first and second hashes do not match, the server-side upload engine 714 may conclude that a hash collision has occurred for at least one of the one or more stored blocks included in the plurality of blocks. In this situation, the server-side upload engine 714 may remedy the situation by requesting the client-side upload engine 762 to send the one or more client blocks that were considered identical to the one or more stored blocks included in the plurality of blocks, and may include in the file copy the one or more client blocks instead of the one or more stored blocks. In some implementations, the possibility of a hash collision is very low and the server-side upload engine 714 may check for it never or rarely, for example, once at the end of the upload and/or before closing the file copy.

Returning to the decision step 922, when the answer at the decision step 922 is negative (the decision step 922: N), for example, when the message received from the hash comparison engine 716 is a hash-not-found message, this answer may indicate that the hash comparison engine 716 has not found a stored hash identical to the client hash. In this case, the second connection server thread 620 may proceed to a step 925, at which the server-side upload engine 714 may send a hash-not-found message to the second connection client thread 640 through the second connection as discussed above in relation to FIG. 6. The second connection server thread 620 may then loop back to step 920, thus completing the client-hash-processing for the client hash.

The above-discussed looping through the client-hash-processing (steps 920-925) may continue throughout the first phase (as discussed above, in relation to FIG. 6 and further discussed below, in relation to FIGS. 11A-11D).

In performing the routine 900 for the uploading, the server-side upload engine 714 may cooperate and exchange data with the client-side upload engine 762. In that regard, FIG. 11A is a flowchart showing an example routine 1100 that may be performed during the uploading by the client-side upload engine 762 shown in FIG. 7, according to some embodiments. As detailed below, during the routine 1100, the client-side upload engine 762 may send data to the server-side upload engine 714 to enable that engine to generate a copy of a client file, as discussed above in relation to FIG. 9.

More specifically, as shown in FIG. 11A, the routine 1100 may begin at a step 1102, at which the client-side upload engine 762 may divide the client file into file sections. The client file may be selected for uploading by another engine, by a routine, by a user, etc. Moreover, as discussed above in relation to FIG. 8A, in some implementations, the file sections may be blocks of equal size, and more specifically of the same size (e.g., 1 KB) used by the hash generation engine 712 in the routine 800 of FIG. 8A.

The routine 1100 may then proceed to step 1104, at which the client-side upload engine 762 may create and initialize a block table, such as the example block table 1150, as described next.

FIGS. 11B-11D show an example block table 1150 that the client-side upload engine 762 may create, write into, and read from during the routine 1100 of FIG. 11A, in a manner described below, and according to some embodiments. More specifically, FIGS. 11B-11D show three different snapshots of the block table 1150 at three different times during one complete execution of the routine 1100 for uploading one client file; the different times for FIGS. 11B, 11C, and 11D respectively being before the start of the uploading, the end of the first phase, and the end of the second phase (which may be the same as the end of the uploading), as further discussed below in the remainder of the detailed description of FIG. 11A.

Further, FIGS. 11B-11D also show a first marker 1160 (arrow in solid line) and a second marker 1170 (arrow in broken line), which mark the block processed at the time of the corresponding snapshot by the first connection client thread 630 and the second connection client thread 640, respectively, as discussed above in the detailed description of FIG. 6 and below in the remainder of the detailed description of FIG. 11A.

In the block table 1150, respective rows may correspond to the data for different blocks of the client file. As shown, in some implementations, the block table 1150 may include three columns, columns 1152, 1154, and 1156.

The column 1152 may include a block identifier (block ID) that the client-side upload engine 762 may use to identify and/or find the block corresponding to the row during the execution of the routine 1100 for one client file. The block ID may be unique during the execution of the routine 1100 for one client file but not unique among different executions of routine 1100 for different client files. In the example block table 1150 in FIGS. 11B-11D, for example, the block ID for the blocks are block numbers, e.g., integer numbers between “1” and the total number of blocks in the client file . The example block table 1150 corresponds to the example of FIG. 6 and assumes that the example client file has been divided into “100” blocks, and that those blocks are identified by corresponding numbers, similar to the blocks in FIG. 6. The example further assumes that the client-side upload engine 762 is able to identify and find blocks based on such integer block IDs. In some embodiments, the client-side upload engine 762, after dividing a specific client file into blocks (at step 1102), may store the blocks in a client-accessible storage medium that is accessible to the client-side upload engine 762; and further may create the block table 1150 and populate the column 1152 with the addresses of those blocks in the client-accessible storage medium. Moreover, upon completion of the operation of the routine 1100 on the specific client file, that is, for example, upon completion of uploading the specific client file, the client-side upload engine 762 may delete the blocks of the specific client file from the client-accessible storage medium, and re-use that storage area, and therefore some or all of the previously used addresses, for newly created blocks of another client file.

The columns 1154 and 1156 in the block table 1150 of FIGS. 11B-11D respectively include a “hash-found flag” and an “upload-candidate flag” for respective rows, as described next.

The hash-found flag in column 1154 may relate to an operation called a hash-check, performed by the second connection client thread 640. When this thread performs a hash-check on a block, it may generate a hash for the block and check (in collaboration with the second connection server thread 620) whether or not an identical hash is found in the hash table 850 (described above in relation to FIG. 8B). Accordingly, in a given row and at a specific time, a true value for the hash-found flag may indicate that the client-side upload engine 762 has previously performed a hash-check on the block corresponding to the row and an identical hash has been found (the corresponding block accordingly being considered in a state called a hash-found state). A false value for the hash-found flag, on the other hand, may indicate the opposite, that is, it may indicate that either no such hash-check has been performed up to that time, or a hash-check has been performed and an identical hash has not been found (the corresponding block accordingly being considered in a state called in a hash-not-found state).

The upload-candidate flag in column 1156, on the other hand, may relate to another operation called an upload-check, performed by the first connection client thread 630. When this thread performs an upload-check on a block, it may upload the block unless the block is in a hash-found state. Accordingly, in a given row and at a specific time, a false value for the upload-candidate flag of column 1156 may indicate that the first connection client thread 630 has previously performed an upload-check on the corresponding block (the corresponding block accordingly being considered, interchangeably, not an upload candidate, not in an upload-candidate state, or in a not-upload-candidate state). A true value for the upload-candidate flag, on the other hand, may indicate the opposite, that is, it may indicate that no such upload-check has been performed on the corresponding block up to that time (the corresponding block accordingly being considered an upload candidate or in an upload-candidate state). The above discussed flags, state, and operations are further detailed next in relation to FIG. 11A.

Returning to the routine 1100 in FIG. 11A, as described above, at the step 1104, the client-side upload engine 762 may create and initialize the block table 1150. An example of one such initialized block table 1150 is shown in FIG. 11B, which (as mentioned earlier) shows the snapshot of the block table 1150 after being created and initialized, and before the start of uploading, according to, for example, the embodiment discussed in relation to FIG. 6. As detailed below, during the uploading the block table 1150 may be modified. As shown in FIG. 11B, the client-side upload engine 762 may initialize all values in column 1154, the hash-found flags, to false (here “F”). These values may indicate that at this point, the blocks listed in the block table 1150 are in a default “hash-not-found” state. Moreover, as also shown in FIG. 11B, the client-side upload engine 762 may initialize the values in column 1156, the upload-candidate flags, to true (here T). These values may indicate that at this point, the blocks listed in the block table 1150 are upload candidates.

The routine 1100 may then proceed to a step 1106, at which client-side upload engine 762 may establish two connections with the server-side upload engine 714, such as the first and second connections discussed above in relation to FIGS. 6 and 9. Further, at a step 1108, the client-side upload engine 762 may establish two threads for exchanging data through the two connections. The two threads may be, for example, the first and second connection client threads 630 and 640, which exchange data with respectively the first and second connection server threads 610 and 620 of the server-side upload engine 714, through the corresponding connections, in the manner also discussed above in relation to FIGS. 6 and 9. Through the data exchange, the first and second connection thread pairs may upload the client file through two phases, as also explained above and further detailed below.

First describing the operations during the first phase, the first connection client thread 630 may select a subset of blocks (such as the first subset of blocks introduced in relation to FIG. 6) including some or all of the blocks listed in the block table 1150, and may perform an upload-check on those blocks in steps 1110-1114 (called an upload-check loop). Upon performing the upload-check, the first connection client thread 630 may change the upload-candidate flag for the selected block to false (F), indicating that the upload-check has been performed on the selected block and that it is no longer a candidate for uploading. These operations are further described below in the detailed descriptions of the steps 1110-1114.

Moreover, also during the first phase, the second connection client thread 640 may select a subset of blocks (such as the second subset of blocks, also introduced in relation to FIG. 6) including some or all of the blocks listed in the block table 1150, and may perform the hash-check on those blocks in steps 1120-1125 (called a hash-check loop), and accordingly either change the state of respective blocks to a hash-found state or leave them in a hash-not-found state. These operations are further described below in the detailed descriptions of steps 1120-1125.

More specifically, during the first phase, the first connection client thread 630 may perform one or more iterations of the upload-check loop (steps 1110-1114) to select blocks and perform an upload-check as follows. In respective iterations of the upload-check loop, the first connection client thread 630 may select a block for the upload-check from a subset of the blocks called “restricted upload-candidates.” In some embodiments, the restricted upload-candidates subset at a time may include blocks that are in the upload-candidate state (that is, blocks for which, up to that time, the first connection client thread 630 has not performed an upload-check) and further for which, up to that time, the second connection client thread 640 has not performed a hash-check. Because of the second condition (no hash-check yet) the upload-check for such a selected block may result in the selected block being uploaded. In such embodiments, the client-side upload engine 762 may keep track of the blocks for which the hash-check has been performed.

In some alternative embodiments, during the first phase, in respective iterations of the upload-check loop (steps 1110-1114), the first connection client thread 630 may select a block for the upload-check from a subset of the blocks called “extended upload-candidates.” In some embodiments, the extended upload-candidates subset may include blocks that are in an upload-candidate state (that is, blocks for which, up to that time, the first connection client thread 630 has not performed an upload-check). The extended upload-candidates subset, therefore, may be a superset of the restricted upload-candidates subset explained above, by additionally including blocks for which, while the first connection client thread 630 has not performed an upload-check, the second connection client thread 640 may have performed a hash-check.

In yet some other alternative embodiments, during the first phase, in respective iterations of the upload-check loop (steps 1110-1114), the first connection client thread 630 may select a block for the upload-check from a subset of the blocks called a “hash-not-found-blocks subset.” In some embodiments, the hash-not-found-blocks subset at a time may include blocks that are in an upload-candidate state (that is, blocks for which, up to that time, the first connection client thread 630 has not performed an upload-check), and moreover have previously undergone the hash-check operation by the second connection client thread 640, and are not in a hash-found state. In some of these alternative embodiments, when the hash-not-found-blocks subset is empty, the first connection client thread 630 may select a block from other subsets, such as the restricted or the extended upload-candidates subset.

Selecting from the hash-not-found-blocks subset may increase the speed of the routine 1100, because it avoids uploading a block that may be in a hash-not-found state by default before undergoing hash-check, but would switch to a hash-found state after undergoing hash-check. The increase in the speed may result in cases in which uploading a block takes longer than doing a hash-check on the block.

The following description of the first phase assumes that the first connection client thread 630 may select the blocks for the upload-check from the restricted upload-candidates subset of blocks. Some or all of the discussions, however, may be applied to the alternative embodiments that select the blocks from the extended upload-candidates or the hash-not-found-blocks subset.

Regarding the details of the upload-check loop (steps 1110-1114), in the beginning, at a decision step 1110 of the first connection client thread 630, the client-side upload engine 762 may determine whether or not one or more upload candidates are left, that is, whether or not the restricted upload-candidates subset is non-empty.

When at least one upload candidate is left (the decision step 1110: Y), the first connection client thread 630 may proceed to a step 1111, at which the client-side upload engine 762 may select a next block (which at a first iteration of the upload-check loop would be the first selected block) from the restricted upload-candidates subset. In some embodiments, the first connection client thread 630 may select a block by selecting a corresponding row of the block table 1150.

In different embodiments, the first connection client thread 630 may use different criteria for selecting the next block. In the embodiment discussed in FIG. 6 and also used in FIGS. 11B-11D (in which the blocks are sequentially numbered from 1 to 100) the first connection client thread 630 may start from a first block, here block #1, and in every iteration of the upload-check loop, select the block with the next block number. Accordingly, as shown in FIG. 11B, after the initialization and before the first iteration of the upload-check loop, the first marker 1160 is located above block #1. During the first iteration of the upload-check loop, the marker 1160 moves down, marking block #1 (that snapshot not shown).

The first connection client thread 630 may then proceed to a decision step 1112, at which the client-side upload engine 762 may determine whether or not the selected block is in a hash-found state by, for example, checking the value of the hash-found flag for the selected block (in column 1154 of the selected row). In cases in which the selected block is not in a hash-found state (decision step 1112: N, indicating that a value of the hash-found flag is false), the first connection client thread 630 may proceed to a step 1113, at which the client-side upload engine 762 may upload the selected block to the server 102 in collaboration with the first connection server thread 610 (as also discussed earlier in relation to, for example, FIGS. 6 and 9). The first connection client thread 630 may then proceed to a step 1114. Returning to the decision step 1112, in cases in which the selected block is not in a hash-found state (decision step 1112: Y, indicating that a value of the hash-found flag is true) the first connection client thread 630 may directly proceed from the decision step 1112 to the step 1114.

The step 1114 may be the last step in the upload-check loop. At this step, the first connection client thread 630 may set the selected block in a not-upload-candidate state (by, for example, setting a value of the corresponding upload-candidate flag in column 1156 of the selected row to false), indicating that an upload-check has been performed on the selected block, and that it is not a candidate for uploading or for upload-check. The first connection client thread 630 may then return to the decision step 1110, thus completing one iteration of the upload-check.

As explained earlier, in the embodiments in which, during the first phase, the first connection client thread 630 selects the blocks for the upload-check from the restricted upload-candidates subset of blocks (and not from, for example, the extended gg subset of blocks) for which the hash-found flag may not be true (as explained above), in every iteration of the upload-check loop, the first connection client thread 630 does reach the step 1113 and upload the selected block. Therefore, in such embodiments, the first connection client thread 630 may speed up the execution of the upload check process during the first phase by eliminating the decision step 1112 and sequentially performing the step 1111, 1113, and 1114 in respective iterations.

During the first phase, while the first connection client thread 630 performs the above-discussed iterations of the upload-check loop, the second connection client thread 640 may perform the hash-check loop (steps 1120-1125) as explained next.

During the first phase, the second connection client thread 640 may perform one or more iterations of the hash-check loop (steps 1120-1125) to select blocks and perform hash-check as follows. In respective iterations of the hash-check loop, the second connection client thread 640 may select a block for hash-check from a subset of the blocks called “hash-check-candidates.” In some embodiments, the hash-check-candidates subset at a time may include blocks for which, up to that time, neither a hash-check nor an upload-check has been performed. Considering the conditions described above for the restricted upload-candidates subset, during the first phase, the hash-check-candidates subset may be the same as the restricted upload-candidates subset. In the example of block table 1150, the restricted upload-candidates (and the hash-check-candidates) subset may, at a point in time, include blocks located between the first and second markers 1160 and 1170 at that time. For example, for the snapshot of FIG. 11B, which corresponds to a time before the start of the first phase, the restricted upload-candidates subset (and also the hash-check-candidates subset) includes blocks #1 to #100.

Regarding the details of the hash-check loop (steps 1120-1125), in the beginning, at a decision step 1120, the second connection client thread 640 may determine whether a hash-check candidate is left, that is, whether the hash-check-candidates subset is non-empty.

When a hash-check-candidate is left (the decision step 1120: Y), the second connection client thread 640 may proceed to a step 1121, at which the client-side upload engine 762 may select the next block (which at a first iteration of the hash-check loop would be the first selected block) from the hash-candidates subset. In some embodiments, the second connection client thread 640 may select a block by selecting a corresponding row of the block table 1150.

In different embodiments, the second connection client thread 640 may use different criteria for selecting the next block. In the embodiment discussed in FIG. 6 and also used in FIGS. 11B-11D (in which the blocks are sequentially numbered from 1 to 100)), the second connection client thread 640 may start from a last block, here block #100, and in consecutive iterations of the hash-check loop, select blocks sequentially in a reverse block number order.

Accordingly, as shown in FIG. 11B, after the initialization and before the first iteration of the hash-check loop, the second marker 1170 may be located below block #100. During the first iteration of the hash-check loop, the marker 1160 may move up to mark block #100 (that snapshot not shown).

The second connection client thread 640 may then proceed to a step 1122 and then to a step 1123, at which steps the client-side upload engine 762 may, respectively, generate a hash or other value for the selected block and send to the second connection server thread 620 the generated hash (and possibly some metadata of the selected block, as described earlier) through the second connection. The second connection server thread 620 may then perform a client-hash-processing, and return a hash-found message or a hash-not found message (as described above in relation to FIG. 9).

The second connection client thread 640 may then proceed to a decision step 1124, at which the client-side upload engine 762 may determine whether it has received a hash-found message from the second connection server thread 620.

When the answer to the decision step 1124 is negative (the decision step 1124: N, indicating that the second connection server thread 620 has not found a stored hash that is identical to the client hash), the second connection client thread 640 may then loop back to the decision step 1120 without modifying the block table 1150. In some embodiments, before looping back, the second connection client thread 640 may verify that that the selected block is in a hash-not-found state (that is, for example, a value of the corresponding hash-found flag in the block table 1150 is false), or otherwise setting the selected block in a hash-not-found state (by setting the value of the corresponding hash-found flag to false).

When the answer to the decision step 1124 is affirmative (the decision step 1124: Y, indicating that the second connection server thread 620 has found a stored hash that is identical to the client hash), the second connection client thread 640 may then proceed to a step 1125. At this step, the client-side upload engine 762 may set the selected block to a hash-found state (by, for example, setting the value of the corresponding hash-found flag in the block table 1150 to true). The second connection client thread 640 may then loop back to the decision step 1120.

The above-described looping back after the decision step 1124 or the step 1125 may complete the hash-check for the selected block and thus complete one iteration of the hash-check loop.

During the first phase, the second connection server thread 620 may continue performing iterations of the hash-check loop 1120-1125 until, at the decision step 1120, there remains no hash-check candidate. When this happens (decision step 1120: N), the second connection server thread 620 may proceed to a step 1126. At this step, the client-side upload engine 762 may stop the second connection server thread 620 and thus end the first phase.

As mentioned earlier, FIG. 11C shows the snapshot of the block table 1150 at the end of the first phase according to, for example, the embodiment discussed in relation to FIG. 6. As also described in relation to FIG. 6, between the start of the first phase (corresponding to the block table 1150 of FIG. 11B) and the end of the first phase (corresponding to the block table 1150 of FIG. 11C), the first connection client thread 630 may perform “22” iterations of the upload-check loop on (and in this case may upload) block #1 to block #22. With respective iterations, at the corresponding row (marked by the first marker 1160), the first connection client thread 630 may set to false a value of the upload-candidate flag in column 1156 (indicating that the corresponding block is not an upload candidate), and then move the first marker 1160 to the next row. In this manner, during the first phase, the first marker 1160 may move down the rows from the 1st row (after the snapshot of FIG. 11B) to the 22nd row (as shown in the snapshot of FIG. 11C).

Similarly, as also described in relation to FIG. 6, during the first phase, the second connection client thread 640 may perform 78 iterations of the hash-check loop on block #100 to block #23 (in order of decreasing block number). With respective iterations, at the corresponding row (marked by the second marker 1170), when it receives a hash-found message, the second connection client thread 640 may set to true the value of the hash-found-flag in column 1154 (indicating that the corresponding block is in a hash-found state, as is the case here for blocks #99, #97, #96, #25, and #24); otherwise, when it does not receive a hash-found message (and may instead receive a hash-not-found message), the second connection client thread 640 may leave as false the value of the hash-found-flag (indicating that the corresponding block is in a hash-not-found state, as is the case here for blocks #100, #98, #95, #27, #26, and #23). The second connection client thread 640 may then move the second marker 1170 to the previous row. In this manner, during the first phase the second marker 1170 may move up the rows from the 100th row (after the snapshot of FIG. 11B) to the 23rd row (as shown in the snapshot of FIG. 11C).

In the embodiment of FIGS. 11B-11D, during the first phase, the restricted upload-candidates subset (which in this case is the same as the hash-check-candidates subset) may include the blocks located between the first marker 1160 and the second marker 1170), which before the start of the first phase (FIG. 11B) includes blocks #1 to #100, and at the end of the first phase (FIG. 11C), includes no blocks, i.e., is empty, as also discussed above (the decision step 1120: N case). The second connection client thread 640 may stop its operation upon determining that the hash-check-candidates subset is empty. Alternatively, in the embodiment of FIGS. 11B-11D, the second connection client thread 640 may determine that there remains no hash-check candidate by determining that for the next block in its list for hash-check (i.e. bock #22), a value of the upload-candidate flag (in column 1156) is false, indicating that the first connection client thread 630 has already performed upload-check (and in this embodiment, has already uploaded) block #22 (as is also the case, in this embodiments, for blocks with lower block numbers, i.e., block #1 to block #21).

After the end of the first phase, the second connection client thread 640 therefore may stop, but the first connection client thread 630 may enter the second phase and continue operation by performing more iterations of the upload-check loop 1110-1114, as discussed next.

During the second phase, the first connection client thread 630 may select the blocks from a subset of blocks for which the upload-check has not been performed, and therefore is an upload-candidate. This subset may, for example, include the extended upload-candidates subset or the hash-not-found-blocks subset. Because the hash-not-found-blocks subset includes members of the extended upload-candidates subset except those that are in a hash-found state, the uploaded blocks would be the same when the first connection client thread 630 selects the blocks from either of these two subsets. In what follows, the subset used is generally called the “upload-candidates.”

During the second phase, in a manner similar to what was described above for the first phase, in respective iterations of the upload-check loop 1110-1114, the first connection client thread 630 may select the blocks from the upload-candidates subset, as long as this subset is not empty, and may perform an upload-check operation on the selected block. In the cases that the subset is the hash-not-found-blocks subset, for the selected blocks the answer to the decision step 1112 is negative, and therefore the first connection client thread 630 may skip the decision step 1112 and the client-side upload engine 762 may perform the upload step 1113 on the selected block and then set the selected block in a not-upload-candidate state.

The iterations of the upload-check loop in the second phase may end when the first connection client thread 630 performs the upload-check iteration on the last member of the upload-candidates subset. After that iteration, at the decision step 1110, the first connection client thread 630 may determine that the upload-candidates subset is empty (the decision step 1110: N) and the first connection client thread 630 may proceed to a step 1130. At this step, the client-side upload engine 762 may send an end-of-file (EOF) message to the first connection server thread 610 through the first connection (as mentioned in relation to the decision step 910 of the routine 900 in FIG. 9). The client-side upload engine 762 may then proceed to a step 1131 to stop the first connection client thread 630. This may end the second phase, the upload, and the routine.

As mentioned earlier, FIG. 11D shows the snapshot of the block table 1150 at the end of the second phase of, for example, the embodiment discussed in relation to FIG. 6.

As also described in relation to FIG. 6, between the end of the first phase, which may also be the start of the second phase (corresponding to the block table 1150 of FIG. 11C) and the end of the second phase (corresponding to the block table 1150 of FIG. 11D), the first connection client thread 630 may perform “78” iterations of the upload-check loop on block #23 to block #100. With respective iterations, at the corresponding row (marked by the first marker 1160), the first connection client thread 630 may upload the block when the hash-found flag of column 1154 is false (e.g., in FIG. 11D, for blocks #23, #26, #27, #95, #98, and #100) and not upload otherwise (e.g., in FIG. 11D, for blocks #24, #25, #96, #97, and #99). Moreover, for respective blocks, the first connection client thread 630 may set to false a value of the upload-flag of column 1156 (indicating that the corresponding block is not an upload candidate or equivalently is in a not-upload-candidate state), and may then move the first marker 1160 to the next row. In this manner, during the second phase, the first marker 1160 may move down the rows from the 23rd row (after the snapshot of FIG. 11C) to the 100th row (as shown in the snapshot of FIG. 11D).

The second connection client thread 640, on the other hand, may end at the end of the first phase and need not operate during the second phase (as also explained earlier, for example, in relation to FIG. 6). Therefore, in the example of FIG. 11D, the second marker 1170 may remain at row “23,” where it ended up at the end of the first phase (shown in FIG. 11C).

G. Example Implementations of Methods, Systems, and Computer-Readable Media in Accordance with the Present Disclosure

The following paragraphs (M1) through (M13) describe examples of methods that may be implemented in accordance with the present disclosure.

(M1) A method may be performed that involves comparing, by a computing system, a first hash with a second hash, the first hash generated by a client device using a first section of a file at the client device and the second hash generated using first data stored by the computing system; and generating, by the computing system and in response to a match between the first and second hashes, a copy of the file with use of the first data to avoid delay caused by upload of the first section of the file from the client device.

(M2) A method may be performed as described in paragraph (M1), and may further involve receiving, by the computing system from the client device, a second section of the file; and using, by the computing system, the second section in generating the copy of the file.

(M3) A method may be performed as described in paragraph (M1) or paragraph (M2), wherein the computing system may receive the second section from the client device through a first connection between the client device and the computing system, and may receive the first hash from the client device through a second connection between the client device and the computing system.

(M4) A method may be performed as described in any of paragraphs (M1) through (M3), and may further involve receiving, by the computing system from the client device, a third hash generated by the client device using a second section of the file; determining, by the computing system, that a match for the third hash has not been found among hashes stored by the computing system; receiving, by the computing system from the client device, the second section of the file; and using, by the computing system, the received second section of the file in generating the copy of the file.

(M5) A method may be performed as described in any of paragraphs (M1) through (M4), and may further involve receiving, by the computing system from the client device, an indicator of a location of the first section within the file; and using, by the computing system, the indicator to determine a location of the first data within the copy of the file.

(M6) A method may be performed as described in any of paragraphs (M1) through (M5), and may further involve dividing, by the computing system, one or more files stored by the computing system into a plurality of file sections, at least one of the plurality of file sections including the first data; generating, by the computing system and using the plurality of file sections, a plurality of hashes including the second hash; and storing, by the computing system, information mapping the plurality of file sections to the plurality of hashes in a hash table stored by the computing system.

(M7) A method may be performed as described in any of paragraphs (M1) through (M6), and may further involve receiving, by the computing system from the client device, a first plurality of sections of the file; receiving, by the computing system from the client device, a first plurality of hashes generated by the client device using a second plurality of sections of the file, the first plurality of hashes matching a second plurality of hashes stored by the computing system and generated by the computing system using second data stored by the computing system; and generating, by the computing system, the copy the file using the first plurality of sections of the file and the second data.

(M8) A method may be performed as described in any of paragraphs (M1) through (M7), and may further involve storing, by computing system, mapping information in a hash table, the mapping information mapping the second plurality of hashes to portions of the second data; identifying, by the computing system, the second plurality of hashes by searching the hash table for matches of the first plurality of hashes; and identifying, by the computing system, the portions of the second data using the mapping information stored in the hash table.

(M9) A method may be performed that involves sending, by a client device to a computing system, a first hash generated by the client device using a first section of a file at the client device; receiving, by the client device from the computing system, an indication that the first hash matches a second hash stored by the computing system, the second hash having been generated using first data stored by the computing system; and refraining, by the client device and based at least in part on the received indication, from sending a copy of the first section of the file to the computing system for inclusion in a copy of the file generated by the computing system.

(M10) A method may be performed as described in paragraph (M9), and may further involve sending, by the client device to the computing system, a second section of the file for inclusion in the copy of the file.

(M11) A method may be performed as described in paragraph (M9) or paragraph (M10), and may further involve sending, by the client device to the computing system, an indicator of a location of the first section within the file for use by the computing system in generating the copy of the file.

(M12) A method may be performed as described in any of paragraphs (M9) through (M11), and may further involve sending, by the client device to the computing system, a first plurality of sections of the file; sending, by the client device to the computing system, a first plurality of hashes generated by the client device using a second plurality of sections of the file; receiving, by the client device from the computing system, one or more messages indicating that the first plurality of hashes match a second plurality of hashes stored by the computing system and generated using second data stored by the computing system; and receiving, by the client device from the computing system, an indication that the computing system has generated the copy of the file using the first plurality of sections of the file and the second data.

(M13) A method may be performed as described in any of paragraphs (M9) through (M12), and may further involve sending, from the client device to the computing system, a third hash generated by the client device using a second section of the file; receiving, by the client device from the computing system, a message that a match for the third hash has not been found among hashes stored by the computing system; and sending, from the client device to the computing system, the second section of the file for inclusion in the copy of the file.

The following paragraphs (Si) through (S13) describe examples of systems and devices that may be implemented in accordance with the present disclosure.

(S1) A computing system may comprise at least one processor, and at least one computer-readable medium. The at least one computer-readable medium may be encoded with instructions which, when executed by the at least one processor, cause the computing system to compare a first hash with a second hash, the first hash generated by a client device using a first section of a file and the second hash generated using first data stored by the computing system, and to generate, in response to a match between the first and second hashes, a copy of the file with use of the first data to avoid delay caused by upload of the first section of the file from the client device.

(S2) A computing system may be configured as described in paragraph (S1), and the at least one computer-readable medium may be further encoded with additional instructions which, when executed by the at least one processor, further cause the computing system to receive, from the client device, a second section of the file; and use the second section in generating the copy of the file.

(S3) A computing system may be configured as described in paragraph (S1) or paragraph (S2), and may be further configured to receive the second section from the client device through a first connection between the client device and the computing system, and to receive the first hash from the client device through a second connection between the client device and the computing system

(S4) A computing system may be configured as described in any of paragraphs (S1) through (S3), and the at least one computer-readable medium may be further encoded with additional instructions which, when executed by the at least one processor, further cause the computing system to receive, from the client device, a third hash generated by the client device using a second section of the file, to determine that a match for the third hash has not been found among hashes stored by the computing system, and to receive, from the client device, the second section of the file; and use the second section in generating the copy of the file.

(S5) A computing system may be configured as described in any of paragraphs (S1) through (S4), and the at least one computer-readable medium may be further encoded with additional instructions which, when executed by the at least one processor, further cause the computing system to receive, from the client device, an indicator of a location of the first section within the file, and to use the indicator to determine a location of the first data within the copy of the file.

(S6) A computing system may be configured as described in any of paragraphs (S1) through (S5), and the at least one computer-readable medium may be further encoded with additional instructions which, when executed by the at least one processor, further cause the computing system to divide one or more files stored by the computing system into a plurality of file sections, at least one of the plurality of file sections including the first data, to generate, using the plurality of file sections, a plurality of hashes including the second hash, and to store information mapping the plurality of file sections to the plurality of hashes in a hash table stored by the computing system.

(S7) A computing system may be configured as described in any of paragraphs (S1) through (S6), and the at least one computer-readable medium may be further encoded with additional instructions which, when executed by the at least one processor, further cause the computing system to receive, from the client device, a first plurality of sections of the file, to receive, from the client device, a first plurality of hashes generated by the client device using a second plurality of sections of the file, the first plurality of hashes matching a second plurality of hashes stored by the computing system and generated by the computing system using second data stored by the computing system, and to generate the copy the file using the first plurality of sections of the file and the second data.

(S8) A computing system may be configured as described in any of paragraphs (S1) through (S7), and the at least one computer-readable medium may be further encoded with additional instructions which, when executed by the at least one processor, further cause the computing system to store mapping information in a hash table, the mapping information mapping the second plurality of hashes to portions of the second data, to identify the second plurality of hashes by searching the hash table for matches of the first plurality of hashes, and to identify the portions of the second data using the mapping information stored in the hash table.

(S9) A client device may comprise at least one processor, and at least one computer-readable medium. The at least one computer-readable medium may be encoded with instructions which, when executed by the at least one processor, cause the client device to send, to a computing system, a first hash generated by the client device using a first section of a file at the client device, to receive, from the computing system, an indication that the first hash matches a second hash stored by the computing system, the second hash having been generated using first data stored by the computing system, and, based at least in part on the received indication, to refrain from sending a copy of the first section of the file to the computing system for inclusion in a copy of the file generated by the computing system.

(S10) A client device may be configured as described in paragraph (S9), and the at least one computer-readable medium may be further encoded with additional instructions which, when executed by the at least one processor, further cause the client device to send, to the computing system, a second section of the file for inclusion in the copy of the file.

(S11) A client device may be configured as described in paragraph (S9) or paragraph (S10), and the at least one computer-readable medium may be further encoded with additional instructions which, when executed by the at least one processor, further cause the client device to send, to the computing system, an indicator of a location of the first section within the file for use by the computing system in generating the copy of the file.

(S12) A client device may be configured as described in any of paragraphs (S9) through (S11), and the at least one computer-readable medium may be further encoded with additional instructions which, when executed by the at least one processor, further cause the client device to send, to the computing system, a first plurality of sections of the file, to send, to the computing system, a first plurality of hashes generated by the client device using a second plurality of sections of the file; receiving, by the client device from the computing system, one or more messages indicating that the first plurality of hashes match a second plurality of hashes stored by the computing system and generated using second data stored by the computing system, and to receive, from the computing system, an indication that the computing system has generated the copy of the file using the first plurality of sections of the file and the second data.

(S13) A client device may be configured as described in any of paragraphs (S9) through (S12), and the at least one computer-readable medium may be further encoded with additional instructions which, when executed by the at least one processor, further cause the client device to send, to the computing system, a third hash generated by the client device using a second section of the file, to receive, from the computing system, a message that a match for the third hash has not been found among hashes stored by the computing system, and to send, to the computing system, the second section of the file for inclusion in the copy of the file.

The following paragraphs (CRM1) through (CRM13) describe examples of computer-readable media that may be implemented in accordance with the present disclosure.

(CRM1) At least one non-transitory, computer-readable medium may be encoded with instructions which, when executed by at least one processor included in a computing system, cause the computing system to compare a first hash with a second hash, the first hash generated by a client device using a first section of a file and the second hash generated using first data stored by the computing system, and to generate, in response to a match between the first and second hashes, a copy of the file with use of the first data to avoid delay caused by upload of the first section of the file from the client device.

(CRM2) At least one computer-readable medium may be configured as described in (CRM1), and may be further encoded with additional instructions which, when executed by the at least one processor, further cause the computing system to receive, from the client device, a second section of the file; and use the second section in generating the copy of the file.

(CRM3) At least one computer-readable medium may be configured as described in paragraph (CRM1) or paragraph (CRM2), and may further be encoded with additional instructions which, when executed by the at least one processor, further cause the computing system to receive the second section from the client device through a first connection between the client device and the computing system, and to receive the first hash from the client device through a second connection between the client device and the computing system

(CRM4) At least one computer-readable medium may be configured as described in any of paragraphs (CRM1) through (CRM3), and may further be encoded with additional instructions which, when executed by the at least one processor, further cause the computing system to receive, from the client device, a third hash generated by the client device using a second section of the file, to determine that a match for the third hash has not been found among hashes stored by the computing system, and to receive, from the client device, the second section of the file; and use the second section in generating the copy of the file.

(CRM5) At least one computer-readable medium may be configured as described in any of paragraphs (CRM1) through (CRM4), and may further be encoded with additional instructions which, when executed by the at least one processor, further cause the computing system to receive, from the client device, an indicator of a location of the first section within the file, and to use the indicator to determine a location of the first data within the copy of the file.

(CRM6) At least one computer-readable medium may be configured as described in any of paragraphs (CRM1) through (CRM5), and may further be encoded with additional instructions which, when executed by the at least one processor, further cause the computing system to divide one or more files stored by the computing system into a plurality of file sections, at least one of the plurality of file sections including the first data, to generate, using the plurality of file sections, a plurality of hashes including the second hash, and to store information mapping the plurality of file sections to the plurality of hashes in a hash table stored by the computing system.

(CRM7) At least one computer-readable medium may be configured as described in any of paragraphs (CRM1) through (CRM6), and may further be encoded with additional instructions which, when executed by the at least one processor, further cause the computing system to receive, from the client device, a first plurality of sections of the file, to receive, from the client device, a first plurality of hashes generated by the client device using a second plurality of sections of the file, the first plurality of hashes matching a second plurality of hashes stored by the computing system and generated by the computing system using second data stored by the computing system, and to generate the copy the file using the first plurality of sections of the file and the second data.

(CRM8) At least one computer-readable medium may be configured as described in any of paragraphs (CRM1) through (CRM7), and may further be encoded with additional instructions which, when executed by the at least one processor, further cause the computing system to store mapping information in a hash table, the mapping information mapping the second plurality of hashes to portions of the second data, to identify the second plurality of hashes by searching the hash table for matches of the first plurality of hashes, and to identify the portions of the second data using the mapping information stored in the hash table.

(CRM9) At least one non-transitory, computer-readable medium may be encoded with instructions which, when executed by at least one processor included in a client device, cause the client device to send, to a computing system, a first hash generated by the client device using a first section of a file at the client device, to receive, from the computing system, an indication that the first hash matches a second hash stored by the computing system, the second hash having been generated using first data stored by the computing system, and, based at least in part on the received indication, to refrain from sending a copy of the first section of the file to the computing system for inclusion in a copy of the file generated by the computing system.

(CRM10) At least one computer-readable medium may be configured as described in paragraph (CRM9), and may be further encoded with additional instructions which, when executed by the at least one processor, further cause the client device to send, to the computing system, a second section of the file for inclusion in the copy of the file.

(CRM11) At least one computer-readable medium may be configured as described in paragraph (CRM9) or paragraph (CRM10), and may be further encoded with additional instructions which, when executed by the at least one processor, further cause the client device to send, to the computing system, an indicator of a location of the first section within the file for use by the computing system in generating the copy of the file.

(CRM12) At least one computer-readable medium may be configured as described in any of paragraphs (CRM9) through (CRM11), and may be further encoded with additional instructions which, when executed by the at least one processor, further cause the client device to send, to the computing system, a first plurality of sections of the file, to send, to the computing system, a first plurality of hashes generated by the client device using a second plurality of sections of the file; receiving, by the client device from the computing system, one or more messages indicating that the first plurality of hashes match a second plurality of hashes stored by the computing system and generated using second data stored by the computing system, and to receive, from the computing system, an indication that the computing system has generated the copy of the file using the first plurality of sections of the file and the second data.

(CRM13) At least one computer-readable medium may be configured as described in any of paragraphs (CRM9) through (CRM12), and may be further encoded with additional instructions which, when executed by the at least one processor, further cause the client device to send, to the computing system, a third hash generated by the client device using a second section of the file, to receive, from the computing system, a message that a match for the third hash has not been found among hashes stored by the computing system, and to send, to the computing system, the second section of the file for inclusion in the copy of the file.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
comparing, by a computing system, a first hash with a second hash, the first hash generated by a client device using a first section of a file at the client device and the second hash generated using first data stored by the computing system; and
generating, by the computing system and in response to a match between the first and second hashes, a copy of the file with use of the first data to avoid delay caused by upload of the first section of the file from the client device.

2. The method of claim 1, further comprising:
receiving, by the computing system from the client device, a second section of the file; and
using, by the computing system, the second section in generating the copy of the file.

3. The method of claim 2, wherein:
the computing system receives the second section from the client device through a first connection between the client device and the computing system; and
the computing system receives the first hash from the client device through a second connection between the client device and the computing system.

4. The method of claim 1, further comprising:
receiving, by the computing system from the client device, a third hash generated by the client device using a second section of the file;
determining, by the computing system, that a match for the third hash has not been found among hashes stored by the computing system;
receiving, by the computing system from the client device, the second section of the file; and
using, by the computing system, the received second section of the file in generating the copy of the file.

5. The method of claim 1, further comprising:
receiving, by the computing system from the client device, an indicator of a location of the first section within the file; and
using, by the computing system, the indicator to determine a location of the first data within the copy of the file.

6. The method of claim 1, further comprising:
dividing, by the computing system, one or more files stored by the computing system into a plurality of file sections, at least one of the plurality of file sections including the first data;
generating, by the computing system and using the plurality of file sections, a plurality of hashes including the second hash; and
storing, by the computing system, information mapping the plurality of file sections to the plurality of hashes in a hash table stored by the computing system.

7. The method of claim 1, further comprising:
receiving, by the computing system from the client device, a first plurality of sections of the file;
receiving, by the computing system from the client device, a first plurality of hashes generated by the client device using a second plurality of sections of the file, the first plurality of hashes matching a second plurality of hashes stored by the computing system and generated by the computing system using second data stored by the computing system; and
generating, by the computing system, the copy the file using the first plurality of sections of the file and the second data.

8. The method of claim 7, further comprising:
storing, by computing system, mapping information in a hash table, the mapping information mapping the second plurality of hashes to portions of the second data;
identifying, by the computing system, the second plurality of hashes by searching the hash table for matches of the first plurality of hashes; and
identifying, by the computing system, the portions of the second data using the mapping information stored in the hash table.

9. A method, comprising:
sending, by a client device to a computing system, a first hash generated by the client device using a first section of a file at the client device;
receiving, by the client device from the computing system, an indication that the first hash matches a second hash stored by the computing system, the second hash having been generated using first data stored by the computing system; and
refraining, by the client device and based at least in part on the received indication, from sending a copy of the first section of the file to the computing system for inclusion in a copy of the file generated by the computing system.

10. The method of claim 9, further comprising:
sending, by the client device to the computing system, a second section of the file for inclusion in the copy of the file.

11. The method of claim 9, further comprising:
sending, by the client device to the computing system, an indicator of a location of the first section within the file for use by the computing system in generating the copy of the file.

12. The method of claim 9, further comprising:
sending, by the client device to the computing system, a first plurality of sections of the file;
sending, by the client device to the computing system, a first plurality of hashes generated by the client device using a second plurality of sections of the file;
receiving, by the client device from the computing system, one or more messages indicating that the first plurality of hashes match a second plurality of hashes stored by the computing system and generated using second data stored by the computing system; and
receiving, by the client device from the computing system, an indication that the computing system has generated the copy of the file using the first plurality of sections of the file and the second data.

13. The method of claim 9, further comprising:
sending, from the client device to the computing system, a third hash generated by the client device using a second section of the file;
receiving, by the client device from the computing system, a message that a match for the third hash has not been found among hashes stored by the computing system; and
sending, from the client device to the computing system, the second section of the file for inclusion in the copy of the file.

14. A computing system, comprising:
at least one processor; and
at least one computer-readable medium encoded with instructions which, when executed by the at least one processor, cause the computing system to:
compare a first hash with a second hash, the first hash generated by a client device using a first section of a file and the second hash generated using first data stored by the computing system, and
generate, in response to a match between the first and second hashes, a copy of the file with use of the first data to avoid delay caused by upload of the first section of the file from the client device.

15. The computing system of claim 14, wherein the at least one computer-readable medium is further encoded with additional instructions which, when executed by the at least one processor, further cause the computing system to:
receive, from the client device, a second section of the file; and
use the second section in generating the copy of the file.

16. The computing system of claim 14, wherein the at least one computer-readable medium is further encoded with additional instructions which, when executed by the at least one processor, further cause the computing system to:
receive, from the client device, a third hash generated by the client device using a second section of the file;
determine that a match for the third hash has not been found among hashes stored by the computing system;
receive, from the client device, the second section of the file; and
use the second section in generating the copy of the file.

17. The computing system of claim 14, wherein the at least one computer-readable medium is further encoded with additional instructions which, when executed by the at least one processor, further cause the computing system to:
receive, from the client device, an indicator of a location of the first section within the file; and
use the indicator to determine a location of the first data within the copy of the file.

18. The computing system of claim 14, wherein the at least one computer-readable medium is further encoded with additional instructions which, when executed by the at least one processor, further cause the computing system to:
divide one or more files stored by the computing system into a plurality of file sections, at least one of the plurality of file sections including the first data;
generate, using the plurality of file sections, a plurality of hashes including the second hash; and
store information mapping the plurality of file sections to the plurality of hashes in a hash table stored by the computing system.

19. The computing system of claim 14, wherein the at least one computer-readable medium is further encoded with additional instructions which, when executed by the at least one processor, further cause the computing system to:
receive, from the client device, a first plurality of sections of the file;
receive, from the client device, a first plurality of hashes generated by the client device using a second plurality of sections of the file, the first plurality of hashes matching a second plurality of hashes stored by the computing system and generated by the computing system using second data stored by the computing system; and
generate the copy the file using the first plurality of sections of the file and the second data.

20. The computing system of claim 19, wherein the at least one computer-readable medium is further encoded with additional instructions which, when executed by the at least one processor, further cause the computing system to:
store mapping information in a hash table, the mapping information mapping the second plurality of hashes to portions of the second data;
identify the second plurality of hashes by searching the hash table for matches of the first plurality of hashes; and
identify the portions of the second data using the mapping information stored in the hash table.
